(19) United States
(12) Patent Application Publication
(10) Pub. No.: US 2021/0357119 A1
(43) Pub. Date: Nov. 18, 2021

(54) ARTIFICIAL INTELLIGENCE-BASED HYBRID RAID CONTROLLER DEVICE

(71) Applicants: Rey Bruce, Austin, TX (US); Ricky Bruce, Austin, TX (US); Lawrence Salazar, Pasig City (PH); Noeme Salazar, Pasig City (PH); Julian Bruce, Austin, TX (US)

(72) Inventors: Rey Bruce, Austin, TX (US); Ricky Bruce, Austin, TX (US); Lawrence Salazar, Pasig City (PH); Noeme Salazar, Pasig City (PH); Julian Bruce, Austin, TX (US)

(21) Appl. No.: 17/322,822

(22) Filed: May 17, 2021

Related U.S. Application Data
(60) Provisional application No. 63/025,899, filed on May 15, 2020.

(51) Int. Cl. G06F 3/06; G06N 3/063

(52) U.S. Cl. CPC G06F 3/062; G06F 3/0659; G06N 3/063; G06F 3/0689; G06F 3/0656

(57) ABSTRACT

The present disclosure provides an artificial intelligence-based hybrid RAID controller device. The artificial intelligence-based hybrid RAID controller device includes CPU to execute instructions to run overall operation of the artificial intelligence-based hybrid RAID controller device. In addition, the artificial intelligence-based hybrid RAID controller device includes XOR/Cipher engine module to perform encryption and decryption to provide data security. Further, the artificial intelligence-based hybrid RAID controller device includes DSP module to perform pre-processing of data for an artificial intelligence inference engine module. Furthermore, the artificial intelligence inference engine module facilitates the artificial intelligence-based hybrid RAID controller device to perform in-storage processing. Moreover, the artificial intelligence-based hybrid RAID controller device includes a plurality of PCIe controller connected to an array of SSDs. The XOR/Cipher engine module embeds XOR engines to perform RAID parity computation to provide data redundancy.

The present application claims the benefit of U.S. Provisional Application No. 63/025,899, filed May 15, 2020; all of which is incorporated herein by reference.

### FIELD OF THE DISCLOSURE

The present disclosure relates to the field of intelligent data storage and processing system, and in particular, relates to an artificial intelligence-based hybrid RAID controller device.

### BACKGROUND OF THE DISCLOSURE

Nowadays, computing devices are used extensively in various sectors such as healthcare, education, marketing, security and so on. Computing devices are used to transfer, process and store data electronically. In addition, computing devices use components such as memories, processors, and input-output interfaces, peripheral interfaces, and an interconnecting bus that connects various components of the computing devices. For example, computing devices include laptops, desktops, smart watches, PDAs, workstations, video games, data centres and so on.

In recent years, there has been a rapid increase in the usage of artificial intelligence and machine learning processing in computing devices to improve their performance. Generally, high-end computing devices include storage or memories and processors provided as separate units. The computing devices typically receive input data from a host device. Further, input data is sent to a remote storage device for storing data. Furthermore, processors process (may use artificial intelligence and machine learning) data and send back the data to the host device. Moreover, the host device processes (using artificial intelligence and machine learning) the received data and sends back data to the computing devices. The above process is repeated until all data stored on remote storage devices is processed.

However, providing separate units for storage and processors leads to several problems. For instance, providing separate units for storage and processing introduce a time delay in processing operations and slow down the computing device. Further, the computing device consumes more power as movement of data back and forth from memories to processors and vice versa increases. Further, providing separate units for storage and processors increases the cost of the computing device. Some of the prior art references that disclose the computing devices including separate units for storage and processors are given below:

US20190019107A1 discloses a data storage system. The storage system includes a host and a remote storage device. The host includes a processor and a memory. The remote storage device is separate from the host. The remote storage device is configured to communicate with the host via an external network. The remote storage device includes a non-volatile memory device and a controller. The controller is configured to control the non-volatile memory device.

U.S. Pat. No. 10,410,693B2 discloses a multiprocessor system with independent direct access to bulk solid state memory resources. The multiprocessor system includes a plurality of processors, each being coupled to each of remaining processors via a cluster of processor interconnects. In addition, the cluster of processor interconnects to form a data distribution network. Further, the multiprocessor system includes a plurality of roots coupled to the processors, each root corresponding to one of the processors. Furthermore, each root includes a memory controller, one or more branches coupled to the memory controller, and a plurality of memory leaves coupled to the branches.

US20120260037A1 discloses a method of configuring resources in a storage array. The method includes a step of determining if data access is first type or second type. In addition, the method includes another step of configuring the storage array as reliable type configuration if the data access is first type. Further, the method includes yet another step of configuring the storage array as a secure type configuration if the data access is second type.

U.S. Pat. No. 10,515,701B1 discloses a method of using boot-time metadata in a storage system. The method includes a step of writing a fragmentation stride to a solid-state storage device of the storage system. The fragmentation stride defines granularity on which fragmentation of erase blocks of the solid-state storage device occurs. The method includes another step of allocating portions of erase blocks for at least one process in the storage system in accordance with the fragmentation stride.

### BRIEF SUMMARY OF THE DISCLOSURE

Embodiments of the present disclosure describe an artificial intelligence-based hybrid RAID controller device, an electronic storage appliance, and a method for providing secure, reliable and efficient data storage with facilitation of the artificial intelligence-based hybrid RAID controller device. In one aspect, the artificial intelligence-based hybrid RAID controller device is described. The artificial intelligence-based hybrid RAID controller device includes CPU to execute instructions to run overall operation of the artificial intelligence-based hybrid RAID controller device. In addition, the artificial intelligence-based hybrid RAID controller device includes XOR/Cipher engine module. The XOR/Cipher engine module embeds AES engines to perform encryption and decryption to provide data security. Further, the artificial intelligence-based hybrid RAID controller device includes DSP module to perform pre-processing of data for an artificial intelligence inference engine module. Furthermore, the artificial intelligence-based hybrid RAID controller device includes the artificial intelligence inference engine module to facilitate the artificial intelligence-based hybrid RAID controller device to perform in-storage processing. Moreover, the artificial intelligence-based hybrid RAID controller device includes a plurality of PCIe controller. The XOR/Cipher engine module embeds XOR engines to perform RAID parity computation to provide data redundancy. The artificial intelligence inference engine module provides artificial intelligence-based processing capabilities to the artificial intelligence-based hybrid RAID controller device. The plurality of PCIe controller is connected to an array of SSDs. Each of the plurality of PCIe controller manages independent SSD of the array of SSDs. The array of SSDs is connected to the artificial intelligence-based hybrid RAID controller device to store data. The artificial intelligence-based hybrid RAID controller device provides the secure, reliable, and scalable electronic storage appliance.

In an embodiment, the artificial intelligence-based hybrid RAID controller device includes SRAM to perform faster operations on data. The SRAM creates a buffer to store data and metadata for short term. The SRAM receives data from the CPU using an internal bus crossbar.

In an embodiment, the artificial intelligence-based hybrid RAID controller device includes DRAM to create the buffer to store data and metadata for short term. The DRAM receives data from the CPU using the internal bus crossbar.

In an embodiment, the artificial intelligence-based hybrid RAID controller device includes an IO controller to facilitate communication with a host through a high-speed interconnect.

In an embodiment, the artificial intelligence-based hybrid RAID controller device supports hot plugging of the array of SSDs.

In an embodiment, each of the array of SSDs is of same configuration or different configuration.

In an embodiment, the artificial intelligence-based hybrid RAID controller device is implemented as a system on a chip (SoC) on a printed circuit board.

In another aspect, a secure, reliable and scalable electronic storage appliance is described. The electronic storage appliance includes a case frame, an artificial intelligence-based hybrid RAID controller device, and an array of SSDs. The case frame encloses the artificial intelligence-based hybrid RAID controller device. The case frame includes an upper frame and a lower frame. The array of SSDs is connected to the artificial intelligence-based hybrid RAID controller device to store data.

In an embodiment, the artificial intelligence-based hybrid RAID controller device includes XOR/Cipher engine module. The XOR/Cipher engine module embeds AES engines to perform encryption and decryption to provide data security. The XOR/Cipher engine module embeds XOR engines to perform RAID parity computation to provide data redundancy.

In an embodiment, the artificial intelligence-based hybrid RAID controller device includes DSP module to perform pre-processing of data for an artificial intelligence inference engine module.

In an embodiment, the artificial intelligence-based hybrid RAID controller device includes the artificial intelligence inference engine module to facilitate the artificial intelligence-based hybrid RAID controller device to perform in-storage processing. The artificial intelligence inference engine module provides artificial intelligence-based processing capabilities to the artificial intelligence-based hybrid RAID controller device.

In an embodiment, the artificial intelligence-based hybrid RAID controller device includes SRAM to perform faster operations on data. The SRAM creates a buffer to store data and metadata for short term. The SRAM receives data from CPU using an internal bus crossbar.

In an embodiment, the artificial intelligence-based hybrid RAID controller device includes DRAM to create the buffer to store data and metadata for short term. The DRAM receives data from the CPU using the internal bus crossbar.

In an embodiment, the artificial intelligence-based hybrid RAID controller device includes a plurality of PCIe controller. The plurality of PCIe controller is connected to the array of SSDs. Each of the plurality of PCIe controller manages independent SSD of the array of SSDs.

In an embodiment, the artificial intelligence-based hybrid RAID controller device includes an IO controller to facilitate communication with a host through a high-speed interconnect.

In yet another aspect, a method for providing secure, reliable and efficient data storage with facilitation of an artificial intelligence-based hybrid RAID controller device is described. The method includes a first step to receive a read request or a write request from a host by an IO controller. In addition, the method includes another step to determine corresponding SSD of an array of SSDs to issue the read request or the write request by CPU. Further, the method includes yet another step to issue a write command for data to be written to the corresponding SSD of the array of SSDs by the CPU to handle the write request. Furthermore, the method includes yet another step to receive data from the corresponding SSD of the array of SSDs by the CPU to handle the read request. The CPU receives data with facilitation of a plurality of PCIe controller.

In an embodiment, the method includes yet another step to implement RAID operation during handling of the read request or the write request received from the host upon activation of XOR/Cipher engine module. The RAID operation is implemented with facilitation of XOR engines embedded inside the XOR/Cipher engine module in the artificial intelligence-based hybrid RAID controller device. The RAID operation is implemented to compute parity block to provide data redundancy.

In an embodiment, the XOR engines embedded inside the XOR/Cipher engine module reads each data block in a set of data blocks buffered in SRAM and DRAM during handling of the write request. The SRAM and the DRAM buffers the parity block to store the parity block in any PCIe controller of the plurality of PCIe controller and the set of data blocks are stored in remaining PCIe controller of the plurality of PCIe controller.

In an embodiment, the method includes yet another step to read the set of data blocks and parity blocks from the array of SSDs by the plurality of PCIe controller during processing of the read request. The plurality of PCIe controller reads the parity blocks to regenerate missing or corrupted data stored in the array of SSDs.

In an embodiment, the method includes yet another step to buffer the read request or the write request received from the host in the SRAM and the DRAM by the IO controller. The IO controller buffers the read request or the write request with facilitation of a high-speed interconnect.

In an embodiment, the method includes yet another step to buffer data received from the corresponding SSD of the array of SSDs in the SRAM and the DRAM by the IO controller. The IO controller buffers data with facilitation of the high-speed interconnect.

In an embodiment, the method includes yet another step to encrypt each data block of the set of data blocks, upon activation by the XOR/Cipher engine module before writing the set of data blocks to the array of SSDs. The XOR/Cipher engine module performs encryption to provide data security.

In an embodiment, the method includes yet another step to decrypt each data block of the set of data blocks received from the array of SSDs during handling of the read command. The decryption is performed by the XOR/Cipher engine module.

In an embodiment, the method includes yet another step to perform in-storage processing by offloading compute functions from the CPU and performing processing of data directly at the array of SSDs by the artificial intelligence-based hybrid RAID controller device. In-storage processing is performed by an artificial intelligence inference engine module and DSP module embedded inside the artificial intelligence-based hybrid RAID controller device.

In an embodiment, the method includes yet another step to perform pre-processing of data upon activation by the DSP module embedded inside the artificial intelligence-based hybrid RAID controller device. The DSP module performs pre-processing of data for the artificial intelligence inference engine module. The DSP module performs pre-processing on data received from the IO controller.

The Features and advantages of the subject matter hereof will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

The present subject matter will now be described in detail with reference to the drawings, which are provided as illustrative examples of the subject matter so as to enable those skilled in the art to practice the subject matter. Notably, the FIGUREs and examples are not meant to limit the scope of the present subject matter to a single embodiment, but other embodiments are possible by way of interchange of some or all of the described or illustrated elements and, further, wherein:

FIG. 1 is a block diagram of an artificial intelligence-based hybrid RAID controller device, in accordance with various embodiments of the present disclosure;

FIG. 2 is a block diagram illustrating a storage system with single host simple SSD RAID topology using the artificial intelligence-based hybrid RAID controller device, in accordance with an embodiment of the present disclosure;

FIG. 3 is a block diagram illustrating a storage system with multiple host SSD RAID topology using the artificial intelligence-based hybrid RAID controller device, in accordance with another embodiment of the present disclosure;

FIG. 4 is a block diagram illustrating a storage system with multi-level SSD RAID topology using the artificial intelligence-based hybrid RAID controller device, in accordance with yet another embodiment of the present disclosure;

FIG. 5 is a block diagram illustrating an architecture of PCIe switch fabric for messaging in a plurality of the artificial intelligence-based hybrid RAID controller devices, in accordance with yet another embodiment of the present disclosure;

FIG. 6 is a block diagram illustrating an architecture of PCIe switch fabric for messaging in a plurality of the artificial intelligence-based hybrid RAID controller devices with or without a plurality of SSDs, in accordance with yet another embodiment of the present disclosure;

FIG. 7 is a block diagram illustrating a storage system with multi-level SSD RAID topology using the artificial intelligence-based hybrid RAID controller device and an external IO controller, in accordance with yet another embodiment of the present disclosure;

FIG. 8 is a block diagram illustrating a scaled version of multi-level SSD RAID topology using the artificial intelligence-based hybrid RAID controller device interconnected with switch fabric and the IO controller, in accordance with yet another embodiment of the present disclosure;

FIG. 9 is a block diagram illustrating the artificial intelligence-based hybrid RAID controller device as a bridge in multi-level SSD RAID topology to connect external PCIe switch, in accordance with yet another embodiment of the present disclosure;

FIG. 10 is a block diagram illustrating RAID implementation in the artificial intelligence-based hybrid RAID controller device along with an option to perform encryption and/or DSP processing with artificial intelligence, in accordance with an embodiment of the present disclosure;

FIG. 11 is a block diagram illustrating multi-level RAID with facilitation of the artificial intelligence-based hybrid RAID controller device, in accordance with another embodiment of the present disclosure;

FIG. 12 is a block diagram illustrating the artificial intelligence-based hybrid RAID controller device performing input processing with an option to perform encryption, DSP processing and/or artificial intelligence processing with RAID, in accordance with yet another embodiment of the present disclosure;

FIG. 13 is a schematic block diagram illustrating the artificial intelligence-based hybrid RAID controller device recovering data in case of interconnect failure, in accordance with an embodiment of the present disclosure;

FIG. 14 is a schematic block diagram illustrating the artificial intelligence-based hybrid RAID controller device recovering data in case of failure of the artificial intelligence-based hybrid RAID controller device, in accordance with another embodiment of the present disclosure;

FIG. 15 is a schematic block diagram illustrating the artificial intelligence-based hybrid RAID controller device recovering data in case of failure of SSD, in accordance with yet another embodiment of the present disclosure;

FIG. 16 is a schematic block diagram illustrating the artificial intelligence-based hybrid RAID controller device recovering data in case of failure of RAID stripe in SSD, in accordance with yet another embodiment of the present disclosure;

FIG. 17 is a schematic block diagram of the artificial intelligence-based hybrid RAID controller device performing single AI processing using an artificial intelligence inference engine module and DSP module, in accordance with an embodiment of the present disclosure;

FIG. 18 is a schematic block diagram of a plurality of the artificial intelligence-based hybrid RAID controller devices performing distributed AI processing using the artificial intelligence inference engine module and the DSP module of the respective artificial intelligence-based hybrid RAID controller devices, in accordance with another embodiment of the present disclosure;

FIG. 19 illustrates an isometric top view of the artificial intelligence-based hybrid RAID controller device implemented on a printed circuit board, in accordance with various embodiments of the present disclosure;

FIG. 20 illustrates an isometric bottom view of the artificial intelligence-based hybrid RAID controller device implemented on the printed circuit board, in accordance with various embodiments of the present disclosure;

FIG. 21 illustrates an exploded isometric view of assembly of the printed circuit board, in accordance with various embodiments of the present disclosure;

FIG. 22 illustrates an exploded isometric internal view of an electronic storage appliance, in accordance with various embodiments of the present disclosure;

FIG. 23 illustrates a cross-sectional view of an upper frame and a lower frame enclosing the printed circuit board, in accordance with various embodiments of the present disclosure;

FIG. 24 illustrates an isometric external view of the electronic storage appliance, in accordance with various embodiments of the present disclosure;

FIG. 25 illustrates a flow diagram of managing a write request by the artificial intelligence-based hybrid RAID controller device received from the another artificial intelligence-based hybrid RAID controller device or a host, in accordance with an embodiment of the present disclosure;

FIG. 26 illustrates a flow diagram of managing a read request by the artificial intelligence-based hybrid RAID controller device received from the another artificial intelligence-based hybrid RAID controller device or the host, in accordance with another embodiments of the present disclosure;

FIG. 27 illustrates a flow chart of handling of the write request by the artificial intelligence-based hybrid RAID controller device, in accordance with yet another embodiment of the present disclosure;

FIG. 28 illustrates a flow chart of handling of write data by the artificial intelligence-based hybrid RAID controller device, in accordance with yet another embodiment of the present disclosure;

FIG. 29 illustrates a flow diagram of handling of the read request by the artificial intelligence-based hybrid RAID controller device, in accordance with yet another embodiment of the present disclosure; and

FIG. 30 illustrates a flow diagram of handling of read data by the artificial intelligence-based hybrid RAID controller device, in accordance with yet another embodiment of the present disclosure.

It will be noted that throughout the appended drawings, like features are identified by like reference numerals.

### DETAILED DESCRIPTION OF THE DISCLOSURE

In the following description, for purposes of explanation, numerous specific details are set forth in order to provide a thorough understanding of the present disclosure. It will be apparent, however, to one skilled in the art that the present disclosure is not limited to these specific details. In other instances, structures and devices are shown in block diagram form only in order to avoid obscuring the present technology.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

Embodiments described herein may be discussed in the general context of computer-executable instructions residing on some form of computer-readable storage media, such as program modules, executed by one or more computers or other devices. By way of example, and not limitation, computer-readable storage media may include non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Some portions of the detailed description that follows are presented and discussed in terms of a process or method. Although steps and sequencing thereof are disclosed in figures herein describing the operations of this method, such steps and sequencing are exemplary. Embodiments are well suited to performing various other steps or variations of the steps recited in the flowchart of the figure herein and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

In some implementations, any suitable computer-usable or computer-readable medium (or media) may be utilized. The computer-readable medium may be a computer-readable signal medium or a computer-readable storage medium. The computer-usable, or computer-readable, storage medium (including a storage device associated with a computing device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a Digital Versatile Disk (DVD), a static random access memory (SRAM), a memory stick, a floppy disk, a mechanically encoded device such as punch-cards or raised structures in a groove having instructions recorded thereon, a media such as those supporting the Internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in computer memory. In the context of the present disclosure, a computer-usable or computer-readable, the storage medium may be any tangible medium that can contain or store a program for use by or in connection with the instruction execution system, apparatus, or device.

In some implementations, a computer-readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer-readable program code may be transmitted using any appropriate medium, including but not limited to the internet, wireline, optical fiber cable, RF, etc. In some implementations, a computer-readable signal medium may be any computer-readable medium that is not a computer-readable storage medium, and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine-dependent instructions, microcode, firmware instructions, state-setting data, or either source code or object code written in any combination of one or more programming languages, including an object-oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. In present implementations, the used language for training may be one of Python, TensorFlow, Bazel, C, C++. Further, the decoder in the user device (as will be discussed) may use C, C++, or any processor-specific ISA. Furthermore, assembly code inside C/C++ may be utilized for the specific operation. Also, ASR (automatic speech recognition) and G2P decoder along with the entire user system can be run in embedded Linux (any distribution), Android, iOS, Windows, or the like, without any limitations. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer-readable program instructions/code by utilizing state information of the computer-readable program instructions to personalize the electronic circuitry, in order to perform aspects of the present disclosure.

In some implementations, the flowchart and block diagrams in the Figures illustrate the architecture, functionality, and operation of possible implementations of apparatus (systems), methods, and computer program products according to various implementations of the present disclosure. Each block in the flowchart and/or block diagrams, and combinations of blocks in the flowchart and/or block diagrams, may represent a module, segment, or portion of code, which includes one or more executable computer program instructions for implementing the specified logical function(s)/act(s). These computer program instructions may be provided to a processor of a general-purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer-implemented process such that the instructions which execute on the computer or other programmable apparatus provide steps for implementing the functions/acts (not necessarily in a particular order) specified in the flowchart and/or block diagram block or blocks or combinations thereof.

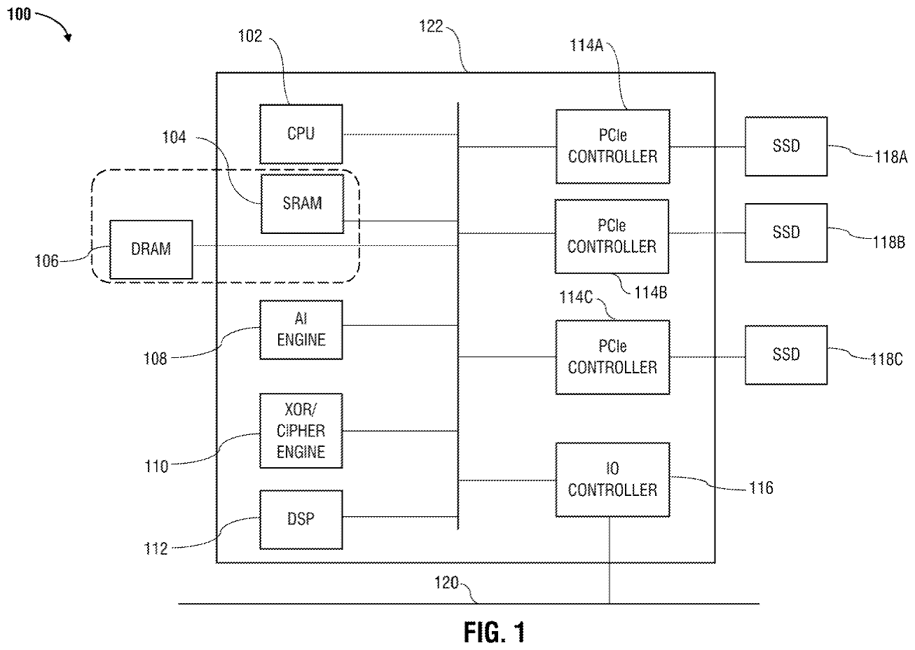

FIG. 1 is a block diagram 100 of an artificial intelligence-based hybrid RAID controller device 122, in accordance with various embodiments of the present disclosure. Block diagram 100 includes the artificial intelligence-based hybrid RAID controller device 122, array of SSDs 118a-118c and a high speed interconnect 120. The artificial intelligence-based hybrid RAID controller device 122 includes CPU 102, SRAM 104, DRAM 106, an artificial intelligence inference engine module 108 (shown as AI engine in FIG. 1), XOR/Cipher engine module 110 (shown as XOR/Cipher engine in FIG. 1), DSP module 112 (shown as DSP in FIG. 1) and a plurality of PCIe controller 114a-114c (shown as PCIe controller in FIG. 1). In addition, the artificial intelligence-based hybrid RAID controller device 122 includes an IO controller 116.

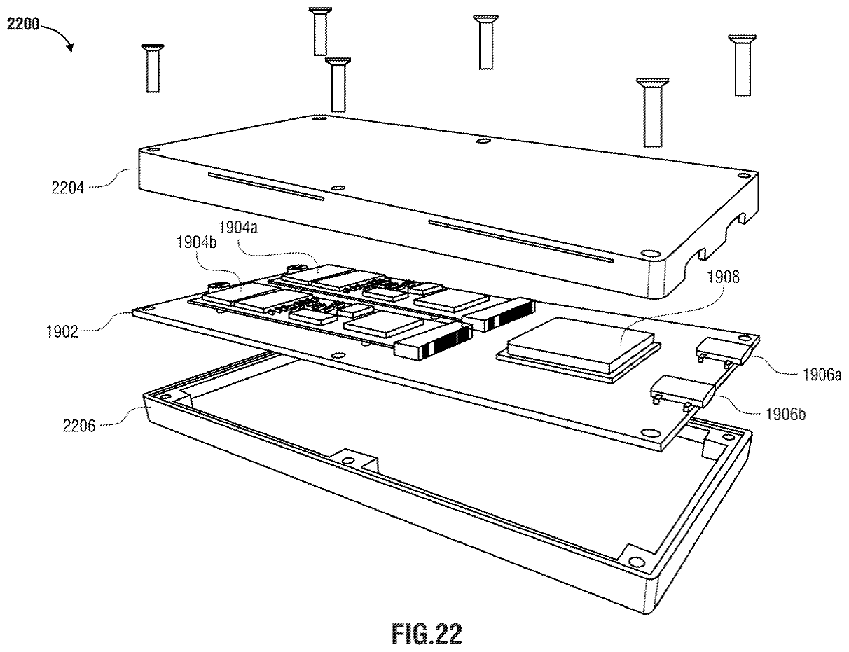

The artificial intelligence-based hybrid RAID controller device 122 is used to provide a secure, highly reliable and highly scalable electronic storage appliance 2202 (as shown in FIG. 22). The term RAID stands for redundant array of independent disks. The artificial intelligence-based hybrid RAID controller device 122 stores the data similar to each of the array of SSDs 118a-118c to provide data redundancy and data recovery in event of crash or failure. In one example, mechanical wear or tear, or power failure causes crash or failure.

The artificial intelligence-based hybrid RAID controller device 122 includes the CPU 102. The CPU 102 is central processing unit of the artificial intelligence-based hybrid RAID controller device 122. The CPU 102 executes instructions to run the overall operation of the artificial intelligence-based hybrid RAID controller device 122. In an embodiment of the present disclosure, number of the CPU 102 inside the controller device 122 may vary.

The artificial intelligence-based hybrid RAID controller device 122 includes the SRAM 104. In addition, the artificial intelligence-based hybrid RAID controller device 122 includes the DRAM 106. The SRAM 104 is static random access memory. The static random access memory is a type of random access memory that stores data in static form. The DRAM 106 is a dynamic random access memory. The dynamic random access memory is a type of random access memory that stores each bit of data in a memory cell, consisting of a tiny capacitor and a transistor.

In an embodiment of the present disclosure, the artificial intelligence-based hybrid RAID controller device 122 includes MRAM or any other similar non-volatile memory to replace the DRAM 106 for cache purpose. MRAM stands for magneto-resistive random access memory. MRAM is a type of non-volatile random access memory that stores data in magnetic domains. In general, cache is hardware or software component inside computing device that stores data temporarily so that it can be accessed faster in future.

In an embodiment of the present disclosure, the artificial intelligence-based hybrid RAID controller device 122 utilizes the SRAM 104 to perform faster operations on data. In an embodiment of the present disclosure, the artificial intelligence-based hybrid RAID controller device 122 utilizes the DRAM 106 to store more capacity of data. The SRAM 104 and the DRAM 106 creates a buffer to store data and metadata for short term.

The artificial intelligence inference engine module 108, the XOR/Cipher engine module 110, and the DSP module 112 access the SRAM 104 and the DRAM 106 using an internal bus crossbar. In one example, the artificial intelligence inference engine module 108 uses the internal bus crossbar to access the SRAM 104 and the DRAM 106. In another example, the XOR/Cipher engine module 110 uses the internal bus crossbar to access the SRAM 104 and the DRAM 106. In yet another example, the DSP module 112 uses the internal bus crossbar to access the SRAM 104 and the DRAM 106.

The artificial intelligence-based hybrid RAID controller device 122 includes the XOR/Cipher engine module 110. In addition, the artificial intelligence-based hybrid RAID controller device 122 embeds the XOR/Cipher engine module 110. The XOR/Cipher engine module 110 provides data security to the artificial intelligence-based hybrid RAID controller device 122. The XOR/Cipher engine module 110 includes AES engines.

In an embodiment of the present disclosure, the XOR/Cipher engine module 110 performs AES encryption. AES (Advanced encryption standard) is a specification for encryption of electronic data. The XOR/Cipher engine module 110 embeds the AES engines to perform encryption and decryption to provide data security. The XOR/Cipher engine module 110 performs encryption and decryption of data as data is stored and retrieved in the array of SSDs 118a-118c. In addition, the XOR/Cipher engine module 110 performs encryption of firmware, directory table, metadata and other data stored on the artificial intelligence-based hybrid RAID controller device 122. Metadata refers to data that describes other data. In general, encryption is a technique of translating or encoding data in another format for security purposes. Further, decryption is a technique that is required to read encrypted data. Furthermore, decryption is performed using an electronic key.

The AES engines are distributed inside the XOR/Cipher engine module 110. In an embodiment of the present disclosure, the AES engines are scalable inside the artificial intelligence-based hybrid RAID controller device 122 without performance degradation. The XOR/Cipher engine module 110 includes XOR engines. The XOR/Cipher engine module 110 embeds the XOR engines to perform faster RAID parity computation to provide data redundancy. In an embodiment of the present disclosure, the XOR engines are distributed inside the XOR/Cipher engine module 110. The XOR engines are scalable inside the artificial intelligence-based hybrid RAID controller device 122 without performance degradation.

The artificial intelligence-based hybrid RAID controller device 122 includes the artificial intelligence inference engine module 108 and the DSP module 112. In addition, the artificial intelligence-based hybrid RAID controller device 122 embeds the artificial intelligence inference engine module 108. Further, the artificial intelligence-based hybrid RAID controller device 122 embeds the DSP module 112. The artificial intelligence inference engine module 108 provides artificial intelligence-based processing capabilities to the artificial intelligence-based hybrid RAID controller device 122.

In general, artificial intelligence is an advanced technology that provides human-like knowledge or capability to computers to learn, predict, or perceive things to perform human-like tasks. In one embodiment, the artificial intelligence inference engine module 108 allows the artificial intelligence-based hybrid RAID controller device 122 to perform tasks based on artificial intelligence. The artificial intelligence inference engine module 108 allows the artificial intelligence-based hybrid RAID controller device 122 to learn from experience, adjust to new inputs and perform human-like tasks. The artificial intelligence inference engine module 108 allows the artificial intelligence-based hybrid RAID controller device 122 to process a large amount of data, and recognize patterns in data by applying mathematical algorithms and calculations.

The DSP module 112 stands for digital signal processing module. Digital signal processing refers to analysing electronic signals in the digital domain and performing operations such as mathematical and computational algorithms, filtering, compression, and the like.

The artificial intelligence inference engine module 108 and the DSP module 112 facilitate the artificial intelligence-based hybrid RAID controller device 122 to perform in-storage processing. In addition, the artificial intelligence inference engine module 108 and the DSP module 112 facilitates the artificial intelligence-based hybrid RAID controller device 122 to perform tasks such as object detection, classification, and the like.

The artificial intelligence-based hybrid RAID controller device 122 includes the plurality of PCIe controller 114a-114c. The plurality of PCIe controller 114a-114c includes PCIe controller 114a, PCIe controller 114b, and PCIe controller 114c. In addition, the array of SSDs 118a-118c include SSD 118a, SSD 118b, and SSD 118c. In an embodiment of the present disclosure, number of PCIe controller of the plurality of PCIe controller 114a-114c, and SSD in the array of SSDs 118a-118c may vary. In one example, number of SSD in the array of SSDs 118a-118c is 3 (as shown in FIG. 1).

The array of SSDs 118a-118c is connected to the artificial intelligence-based hybrid RAID controller device 122 to store data. Each SSD of the array of SSDs 118a-118c is a solid state drive. The solid state drive is a solid-state storage device used in computing devices to store electronic data persistently. The solid state drive utilizes non-volatile memories such as flash memory, ferroelectric random access memory (FRAM), magnetic random access memory (MRAM), and the like to store data. The non-volatile memories refer to memories that store data even if the main power is turned off.

Non-volatile memory is a type of computer memory that can store computer data even if power is turned off. Flash memory is a type of computer memory that can easily be erased and reprogrammed. FRAM is a random access memory that uses a ferroelectric layer to achieve non-volatility. MRAM is a type of non-volatile random access memory that stores data in magnetic domain.

The plurality of PCIe controller 114a-114c is connected to the array of SSDs 118a-118c. In addition, each of the plurality of PCIe controller 114a-114c manages independent SSD of the array of SSDs 118a-118c. PCIe controller 114a manages SSD 118a. In addition, PCIe controller 114b manages SSD 118b. Further, PCIe controller 114c manages SSD 118c. In an embodiment of the present disclosure, each PCIe controller manages separate SSD.

The artificial intelligence-based hybrid RAID controller device 122 includes the IO controller 116. The IO controller 116 facilitates communication with a host through the high speed interconnect 120. In an embodiment of the present disclosure, the high speed interconnect 120 is used to connect the artificial intelligence-based hybrid RAID controller device 122 with the host.

In one example, the high speed interconnect 120 supports SAS interface. SAS interface is a point-to-point serial protocol used to transfer data to and from computer-storage devices such as the array of SSDs 118a-118c.

In another example, the high speed interconnect 120 supports PCIe interface. PCIe interface stands for peripheral component interconnect express interface. In general, PCIe interface is used inside the motherboard of the computer. Also, PCIe interface may be used to connect devices or components for high speed data transfer. PCIe interface interconnects high speed and high-performance components such as graphic cards, network interface cards, hard disk drives, solid state drives, and the like.

In yet another example, the high speed interconnect 120 supports FC (fibre channel) interface. FC interface stands for fibre channel interface. FC interface is high-speed data transfer protocol that provides in-order, lossless delivery of data.

In yet another example, the high speed interconnect 120 supports Ethernet. Ethernet interface is a networking interface that allows transmission of data over the internet. In yet another example, the high speed interconnect 120 supports wireless radio interface to transmit to and receive from remote control. In yet another example, the high speed interconnect 120 supports any other similar interface.

The artificial intelligence-based hybrid RAID controller device 122 performs a method to provide secure, reliable and efficient data storage. The IO controller 116 receives a read request or a write request from the host. In general, host is a computer device or other device that communicates with other hosts in a network. The IO controller 116 buffers the read request or the write request received from the host in the SRAM 104 and the DRAM 106. The IO controller 116 utilizes the high speed interconnect 120 to buffer the read request or the write request. In addition, the IO controller 116 buffers write data in the SRAM 104 and the DRAM 106 in case of the write request received from the host. The write data is data to be written in the array of SSDs 118a-118c in case of the write request. The IO controller 116 utilizes the high speed interconnect 120 to buffer the write data.

The CPU 102 handles input/output interface, management of the array of SSDs 118a-118c and processing of buffered commands and associated data. The CPU 102 determines corresponding SSD of the array of SSDs 118a-118c to issue the read request or the write request. The CPU 102 distributes data to the array of SSDs 118a-118c. In addition, the CPU 102 translates the read request or the write request to commands that can be easily interpreted by the plurality of PCIe controller 114a-114c.

In an embodiment of the present disclosure, the IO controller 116 receives the read request from the host. In addition, the CPU 102 issues read command to the corresponding SSD of the array of SSDs 118a-118c that contains data requested by the host. The CPU 102 receives data from the corresponding SSD of the array of SSDs 118a-118c. Also, the CPU 102 buffers data in the SRAM 104 and the DRAM 106. The SRAM 104 receives data from the CPU 102 using the internal bus crossbar. In addition, the DRAM 106 receives data from the CPU 102 using the internal bus crossbar.

In an embodiment of the present disclosure, the CPU 102 receives data from the corresponding SSD of the array of SSDs 118a-118c with facilitation of the plurality of PCIe controller 114a-114c. The CPU 102 utilizes the internal bus crossbar to buffer data in the SRAM 104 and the DRAM 106. The IO controller 116 retrieves buffered data and returns buffered data to the host.

In another embodiment of the present disclosure, the IO controller 116 receives the write request from the host. In addition, the IO controller 116 receives the write data to be written to the corresponding SSD of the array of SSDs 118a-118c. In an embodiment of the present disclosure, the IO controller 116 receives the write data from the host. Furthermore, the CPU 102 issues a write command for data to be written to corresponding SSD of the array of SSDs 118a-118c. Moreover, the CPU 102 issues the write data to be written to corresponding SSD of the array of SSDs 118a-118c.

In an embodiment of the present disclosure, the artificial intelligence-based hybrid RAID controller device 122 implements RAID operation during handling of the read request and the write request. The artificial intelligence-based hybrid RAID controller device 122 implements the RAID operation upon activation of the XOR/Cipher engine module 110. The Artificial intelligence-based hybrid RAID controller device 122 utilizes the XOR engines embedded inside the XOR/Cipher engine module 110 to implement the RAID operation. The XOR/Cipher engine module 110 implements the RAID operation to compute parity block to provide data redundancy. In an embodiment of the present disclosure, the artificial intelligence-based hybrid RAID controller device 122 implements RAID 5 configuration or any other similar RAID configuration.

RAID 5 configuration is a redundant array of independent disks configuration that uses disk striping with parity. Data striping refers to the technique of dividing body of data into blocks and spreading blocks in multiple disk drives. Parity bit refers to check bit added to a string of binary code for error detection. The XOR/Cipher engine module 110 activates the XOR engines to compute parity. The XOR engines provide ability of data redundancy and data recovery to the artificial intelligence-based hybrid RAID controller device 122.

The XOR engines embedded inside the XOR/Cipher engine module 110 reads each data block in a set of data blocks buffered in the SRAM 104 and the DRAM 106 during processing of the write request. The XOR operation of all data blocks in the set of data blocks is the parity block. In addition, the SRAM 104 and the DRAM 106 buffer the parity block. Further, any one PCIe controller of the plurality of PCIe controller 114a-114c stores the parity block and remaining PCIe controllers of the plurality of PCIe controller 114a-114c store the set of data blocks for each data set.

The plurality of PCIe controller 114a-114c reads the set of data blocks and parity blocks from the array of SSDs 118a-118c during processing of the read request. The XOR engines compute the parity block from the set of data blocks. The plurality of PCIe controller 114a-114c reads the parity blocks to regenerate missing or corrupted data stored in the array of SSDs 118a-118c if any of the array of SSDs 118a-118c fails to retrieve data block or returns corrupted data block from the set of data blocks.

The AES engines perform encryption and decryption of the set of data blocks. The XOR/Cipher engine module 110 performs encryption on each data block of the set of data blocks during the write request before writing the set of data blocks to the array of SSDs 118a-118c upon activation of the encryption operation. The XOR/Cipher engine module 110 performs encryption to provide data security. The XOR engines read the set of data blocks to compute the parity block to provide data redundancy and recovery. The AES engines encrypt the set of data blocks to provide protection and security to data.

The XOR/Cipher engine module 110 performs decryption on each data block of the set of data blocks received from the array of SSDs 118a-118c during handling of the read command. The XOR/Cipher engine module 110 performs decryption.

The SRAM 104 and the DRAM 106 stores encrypted set of data blocks. The plurality of PCIe controller 114a-114c utilizes the array of SSDs 118a-118c to store the encrypted set of data blocks.

During processing of the read request, the AES engines decrypt each of the set of data blocks read from the array of SSDs 118a-118c. Further, the XOR engines use the set of data blocks to compute the parity block. In an embodiment of the present disclosure, the AES engines encrypt metadata such as code and directory tables.

The artificial intelligence-based hybrid RAID controller device 122 facilitates offloading of compute functions from the CPU 102 through in-storage processing. In-storage processing refers to processing inside a storage device. In other words, in-storage processing refers to processing of data where data resides. The artificial intelligence-based hybrid RAID controller device 122 performs processing of data directly at the array of SSDs 118a-118c. The artificial intelligence inference engine module 108 and the DSP module 112 provide in-storage processing capabilities to the artificial intelligence-based hybrid RAID controller device 122.

The artificial intelligence-based hybrid RAID controller device 122 transfers fewer data back and forth from the CPU 102 and the array of SSDs 118a-118c due to capability of in-storage processing. In an embodiment of the present disclosure, the capability of in-storage processing improves the overall performance of the artificial intelligence-based hybrid RAID controller device 122. In addition, the capability of in-storage processing enables low power consumption in the artificial intelligence-based hybrid RAID controller device 122.

The artificial intelligence-based hybrid RAID controller device 122 performs pre-processing of data upon activation of the DSP module 112. The DSP module 112 performs pre-processing of data for the artificial intelligence inference engine module 108. The DSP module 112 performs pre-processing on data received from the IO controller 116. Further, the SRAM 104 and the DRAM 106 buffers data. In another embodiment of the present disclosure, the DSP module 112 and the artificial intelligence inference engine module 108 facilitates to perform operations such as SLAM, LiDAR and the like. SLAM stands for simultaneous localization and mapping. LiDAR stands for Light Detection and Ranging. LiDAR is a remote sensing method that illuminates target with laser light and measures reflection with a sensor to measure distance.

However, the artificial intelligence-based hybrid RAID controller device 122 utilizes each of the artificial intelligence inference engine module 108, the DSP module 112 and the XOR/Cipher engine module 110 independently and interchangeably in any order.

In an embodiment of the present disclosure, the artificial intelligence inference engine module 108 improves the inference performance of neural networks. In general, neural networks are a series of algorithms, modelled loosely after the human brain that endeavours to recognize underlying relationships or patterns in a set of data.

In an embodiment of the present disclosure, the artificial intelligence-based hybrid RAID controller device 122 receives commands for the artificial intelligence inference engine module 108 through the IO controller 116. The commands enable the artificial intelligence inference engine module 108 to autonomously perform inferences using neural network on data sets stored in the array of SSDs 118a-118c.

The CPU 102 instructs the plurality of PCIe controller 114a-114c to transfer requested data from the array of SSDs 118a-118c to the SRAM 104 and the DRAM 106. The artificial intelligence inference engine module 108 utilizes the internal bus crossbar to access requested data. The artificial intelligence inference engine module 108 performs computing operations on requested data.

In an embodiment of the present disclosure, the artificial intelligence-based hybrid RAID controller device 122 is implemented as ASIC configuration. ASIC stands for application-specific integrated circuit. ASIC is an integrated circuit chip customized for a particular use, rather than general use. In another embodiment of the present disclosure, the artificial intelligence-based hybrid RAID controller device 122 is implemented as FPGA configuration. FPGA stands for field programmable gate array. FPGA is an integrated circuit that can be configured by a manufacturer or designer after manufacturing. In yet another embodiment of the present disclosure, the artificial intelligence-based hybrid RAID controller device 122 is implemented as any other configuration of the like.

In an embodiment of the present disclosure, the array of SSDs 118a-118c support storage capacity in Gigabyte, Terabyte, Petabyte or any other storage size.

In one example, the array of SSDs 118a-118c include solid state drives of MLC configuration. MLC stands for multi-level cell. In another example, the array of SSDs 118a-118c include solid state drives of 3D-NAND configuration. 3D-NAND is flash memory technology in which memory cells are stacked vertically to increase capacity.

In yet another example, the array of SSDs 118a-118c includes solid state drives of ZNAND configuration. Z-NAND is a high-performance improvement of 3D-NAND technology. In yet another example, the array of SSDs 118a-118c includes solid state drives of XL-flash configuration. XL-flash memory configuration is a low latency prototype of 3D-NAND technology.

In yet another example, the array of SSDs 118a-118c include Intel® Optane™ solid state drives. In yet another example, the array of SSDs 118a-118c includes Quantx solid state drives. However, the array of SSDs 118a-118c is not limited to above-mentioned solid state drives.

In an embodiment of the present disclosure, the artificial intelligence-based hybrid RAID controller device 122 supports hot plugging of the array of SSDs 118a-118c. SSD hot plugging allows the artificial intelligence-based hybrid RAID controller device 122 to connect additional SSDs of any configuration without a restart. In an embodiment of the present disclosure, each SSD of the array of SSDs 118a-118c is of same configuration or different configuration.

The artificial intelligence-based hybrid RAID controller device 122 facilitates to perform HPC (high-performance computing). The artificial intelligence-based hybrid RAID controller device 122 allows the CPU 102 and the artificial intelligence inference engine module 108 to reside closely with the array of SSDs 118a-118c to perform HPC. In an embodiment of the present disclosure, the artificial intelligence-based hybrid RAID controller device 122 facilitates to perform data fusion, and data processing. In an embodiment of the present disclosure, the artificial intelligence-based hybrid RAID controller device 122 facilitates to perform predictive data analytics.

The artificial intelligence-based hybrid RAID controller device 122 facilitates to perform distributed, parallel processing and improves system-wide performance. In case of failure, the artificial intelligence-based hybrid RAID controller device 122 facilitates to perform recovery of a single block of data in SSD or complete unit of the array of SSDs 118a-118c using implementation of RAID. In an embodiment of the present disclosure, the artificial intelligence-based hybrid RAID controller device 122 provides real-time predictions about harmful events and hazardous environmental conditions.

In an embodiment of the present disclosure, the artificial intelligence-based hybrid RAID controller device 122 is equipped with SLAM engines. In one example, the DSP module 112 includes SLAM engines. In another example, the artificial intelligence inference engine module 108 includes SLAM engines. SLAM engines allow the artificial intelligence-based hybrid RAID controller device 122 to understand and map the outer physical world using feature points. The artificial intelligence inference engine module 108 utilizes SLAM engines to construct and update the map of the unknown environment in real-time. SLAM engines allow the artificial intelligence-based hybrid RAID controller device 122 to operate seamlessly in harsh terrain.

The artificial intelligence inference engine module 108 and the DSP module 112 applies logical rules to knowledgebase stored in the array of SSDs 118a-118c to formulate new and useful information. The artificial intelligence inference engine module 108 and the DSP module 112 allows the artificial intelligence-based hybrid RAID controller device 122 to perform tasks such as comparison, prediction, analysis, generation of insights and the like.

In an embodiment of the present disclosure, the artificial intelligence-based hybrid RAID controller device 122 supports secure erase sanitization process. Secure erase sanitization is used to destroy data stored in the artificial intelligence-based hybrid RAID controller device 122 to prevent unauthorized access.

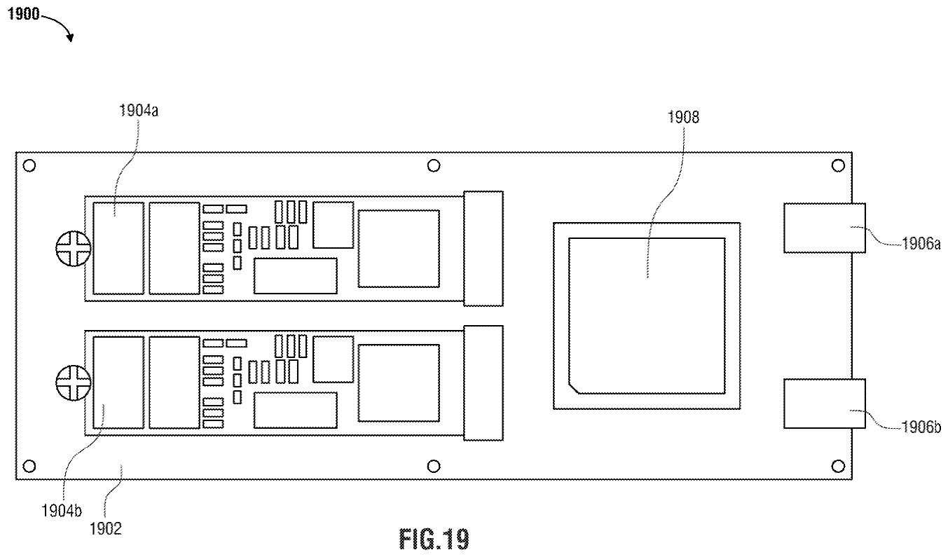

The artificial intelligence-based hybrid RAID controller device 122 is implemented as a system on a chip (SoC 1908) (as shown in FIG. 19) on a printed circuit board 1902 (as shown in FIG. 19). The artificial intelligence-based hybrid RAID controller device 122 provides the secure, reliable, and scalable electronic storage appliance 2202 (as shown in FIG. 22).

In an embodiment of the present disclosure, the array of SSDs 118a-118c are replaceable. In one example, the artificial intelligence-based hybrid RAID controller device 122 uses the dual-switch, dual-path, dual-power supply, hot-swappable array of SSDs 118a-118c. In an embodiment of the present disclosure, the artificial intelligence-based hybrid RAID controller device 122 utilizes the artificial intelligence inference engine module 108, the DSP module 112 and the XOR/Cipher engine module 110 interchangeably in any order.

In an embodiment of the present disclosure, the artificial intelligence inference engine module 108, the DSP module 112 and the XOR/Cipher engine module 110 includes DMA engines. DMA engines provides ability to input-output devices to access the SRAM 104 and the DRAM 106 without use of the CPU 102.

In an embodiment of the present disclosure, the artificial intelligence-based hybrid RAID controller device 122 is capable to perform speech recognition processing for voice user interface. Speech recognition is ability of any machine to recognize words and phrases in spoken language and convert them to a machine-readable format. In addition, voice user interface (VOI) is an interface that allows users to interact with any machine or system using speech or voice commands.

In one example, the artificial intelligence-based hybrid RAID controller device 122 utilizes the artificial intelligence inference engine module 108 to perform speech recognition. In another example, the artificial intelligence-based hybrid RAID controller device 122 utilizes the DSP module 112 to perform speech recognition.

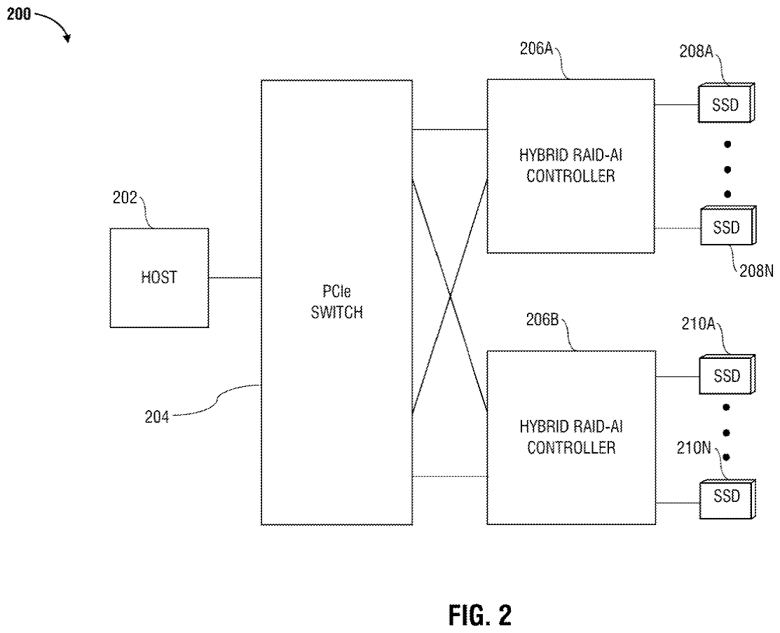

FIG. 2 is a block diagram illustrating a storage system with a single host simple SSD RAID topology 200 using the artificial intelligence-based hybrid RAID controller device 122 (of FIG. 1), in accordance with an embodiment of the present disclosure.

The single host simple SSD RAID topology 200 includes host 202, PCIe switch 204, an artificial intelligence-based hybrid RAID controller device 206a (shown as hybrid RAID-AI controller in FIG. 2), and an artificial intelligence-based hybrid RAID controller device 206b (shown as hybrid RAID-AI controller in FIG. 2). In addition, single host simple SSD RAID topology 200 includes first array of SSDs 208a-208n (shown as SSD in FIG. 2), and second array of SSDs 210a-210n (shown as SSD in FIG. 2).

The artificial intelligence-based hybrid RAID controller device 206a is identical to the artificial intelligence-based hybrid RAID controller device 122 (of FIG. 1). The artificial intelligence-based hybrid RAID controller device 206b is identical to the artificial intelligence-based hybrid RAID controller device 122 (of FIG. 1).

Each SSD of the first array of SSDs 208a-208n is identical to SSD of the array of SSDs 118a-118c. Also, each SSD of the second array of SSDs 210a-210n is identical to SSD of the array of SSDs 118a-118c.

The host 202 is a computer or device connected to a network. In an embodiment of the present disclosure, the host 202 sends the read request or the write request to the artificial intelligence-based hybrid RAID controller device 206a or the artificial intelligence-based hybrid RAID controller device 206b. In one example, the host 202 utilizes PCIe switch 204 to connect to the artificial intelligence-based hybrid RAID controller device 206a. In another example, the host 202 utilizes PCIe switch 204 to connect to the artificial intelligence-based hybrid RAID controller device 206b. In yet another example, the host 202 utilizes PCIe switch 204 to connect to more number of the artificial intelligence-based hybrid RAID controller devices.

The artificial intelligence-based hybrid RAID controller device 206a manages the first array of SSDs 208a-208n. The artificial intelligence-based hybrid RAID controller device 206b manages the second array of SSDs 210a-210n. In an embodiment of the present disclosure, number of SSDs in the first array of SSDs 208a-208n, and the second array of SSDs 210a-210n may vary.

PCIe switch 204 uses redundant connections to connect to the artificial intelligence-based hybrid RAID controller device 206a, and the artificial intelligence-based hybrid RAID controller device 206b to provide redundancy.

In an embodiment of the present disclosure, the artificial intelligence-based hybrid RAID controller device 206a receives the read request or the write request from the host 202. The artificial intelligence-based hybrid RAID controller device 206a processes the read request or the write request. The artificial intelligence-based hybrid RAID controller device 206a communicates with the corresponding SSD of the first array of SSDs 208a-208n to process the read request or the write request (as explained above in FIG. 1).

In another embodiment of the present disclosure, the artificial intelligence-based hybrid RAID controller device 206b receives the read request or the write request from the host 202. The artificial intelligence-based hybrid RAID controller device 206b processes the read request or the write request. The artificial intelligence-based hybrid RAID controller device 206b communicates with the corresponding SSD of the second array of SSDs 210a-210n to process the read request or the write request (as explained above in FIG. 1).

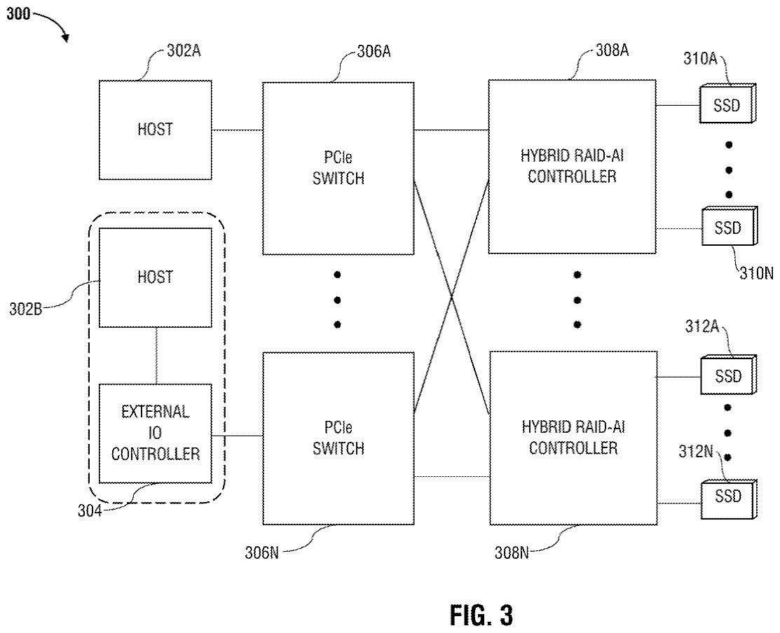

FIG. 3 is a block diagram illustrating a storage system with multiple host SSD RAID topology 300 using the artificial intelligence-based hybrid RAID controller device 122 (of FIG. 1), in accordance with another embodiment of the present disclosure.

The multiple host SSD RAID topology 300 includes host 302a, host 302b, and an external IO controller 304. In addition, multiple host SSD RAID topology 300 includes a plurality of PCIe switch 306a-306n (shown as PCIe switch in FIG. 3), a plurality of artificial intelligence-based hybrid RAID controller devices 308a-308n (shown as hybrid RAID-AI controller in FIG. 3), and a plurality of array of SSDs. The plurality of array of SSDs includes first array of SSDs 310a-310n (shown as SSD in FIG. 3), and second array of SSDs 312a-312n (shown as SSD in FIG. 3).

In an embodiment of the present disclosure, number of PCIe switch in the plurality of PCIe switch 306a-306n may vary. In an embodiment of the present disclosure, number of the artificial intelligence-based hybrid RAID controller devices in the plurality of artificial intelligence-based hybrid RAID controller devices 308a-308n may vary. In an embodiment of the present disclosure, number of SSDs in the plurality of array of SSDs may vary.

The host 302a is identical to the host 202 of FIG. 2. The host 302b is identical to the host 202 of FIG. 2. In addition, each of the plurality of PCIe switch 306a-306n is identical to PCIe switch 204 of FIG. 2. Further, each of the plurality of artificial intelligence-based hybrid RAID controller devices 308a-308n is identical to the artificial intelligence-based hybrid RAID controller device 122 of FIG. 1. Furthermore, each of the plurality of SSDs is identical to the array of SSDs 118a-118c of FIG. 1.

In an embodiment of the present disclosure, the host 302a uses one of the plurality of PCIe switch 306a-306n to connect to one of the plurality of artificial intelligence-based hybrid RAID controller devices 308a-308n.

The host 302a is connected to the artificial intelligence-based hybrid RAID controller device 308a using PCIe switch 306a. The host 302b is connected to the external IO controller 304. The host 302b is connected to the external IO controller 304 using one or more interfaces such as SAS, PCIe, FC, Ethernet, and the like (as explained above in FIG. 1).

In one example, the host 302b is connected to the external IO controller 304 using SAS interface. In another example, the host 302b is connected to the external IO controller 304 using PCIe interface. In yet another example, the host 302b is connected to the external IO controller 304 using FC interface. In yet another example, the host 302b is connected to the external IO controller 304 using Ethernet interface.

The external IO controller 304 uses one of the plurality of PCIe switch 306a-306n to connect to one of the plurality of artificial intelligence-based hybrid RAID controller devices 308a-308n. Further, each of the plurality of artificial intelligence-based hybrid RAID controller devices 308a-308n is connected to an array of SSDs of the plurality of array of SSDs.

In one example, the artificial intelligence-based hybrid RAID controller device 308a manages the first array of SSDs 310a-310n. In another example, the artificial intelligence-based hybrid RAID controller device 308n manages the second array of SSDs 312a-312n.

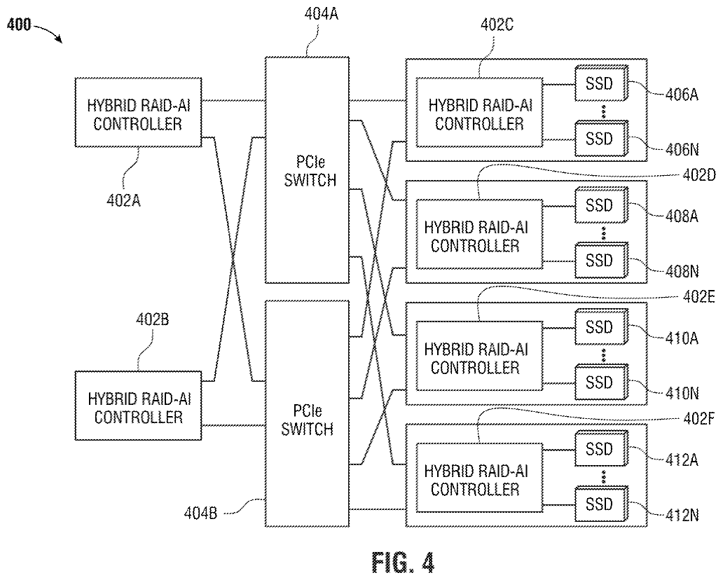

FIG. 4 is a block diagram illustrating a storage system with multi-level SSD RAID topology 400 using the artificial intelligence-based hybrid RAID controller device 122 (of FIG. 1), in accordance with yet another embodiment of the present disclosure.

The multi-level SSD RAID topology 400 includes an artificial intelligence-based hybrid RAID controller device 402a (shown as hybrid RAID-AI controller in FIG. 4), an artificial intelligence-based hybrid RAID controller device 402b (shown as hybrid RAID-AI controller in FIG. 4), an artificial intelligence-based hybrid RAID controller device 402c (shown as hybrid RAID-AI controller in FIG. 4), an artificial intelligence-based hybrid RAID controller device 402d (shown as hybrid RAID-AI controller in FIG. 4), an artificial intelligence-based hybrid RAID controller device 402e (shown as hybrid RAID-AI controller in FIG. 4), and an artificial intelligence-based hybrid RAID controller device 402f (shown as hybrid RAID-AI controller in FIG. 4).

In addition, the multi-level SSD RAID topology 400 includes PCIe switch 404a, PCIe switch 404b, and a plurality of array of SSDs. The plurality of array of SSDs includes first array of SSDs 406a-406n (shown as SSD in FIG. 4), second array of SSDs 408a-408n (shown as SSD in FIG. 4), third array of SSDs 410a-410n (shown as SSD in FIG. 4), and fourth array of SSDs 412a-412n (shown as SSD in FIG. 4).

The artificial intelligence-based hybrid RAID controller devices 402a-402f are identical to the artificial intelligence-based hybrid RAID controller device 122 of FIG. 1. PCIe switch 404a is identical to PCIe switch 204 of FIG. 2. PCIe switch 404b is identical to PCIe switch 204 of FIG. 2. In addition, each of the plurality of array of SSDs is identical to the array of SSDs 118a-118c.

The artificial intelligence-based hybrid RAID controller devices 402a-402f utilizes PCIe switch 404a, 404b to connect with the artificial intelligence-based hybrid RAID controller devices 402a, 402b. In addition, the artificial intelligence-based hybrid RAID controller device 402c manages the first array of SSDs 406a-406n. Further, the artificial intelligence-based hybrid RAID controller device 402d manages the second array of SSDs 408a-408n. Furthermore, the artificial intelligence-based hybrid RAID controller device 402e manages the third array of SSDs 410a-410n. Moreover, the artificial intelligence-based hybrid RAID controller device 402f manages the fourth array of SSDs 412a-412n.

In an embodiment of the present disclosure, each of the artificial intelligence-based hybrid RAID controller devices 402c-402f manages separate array of SSDs to perform distributed processing.

In an embodiment of the present disclosure, each component shown in block diagram 400 is connected with every other component through multiple lanes. Multiple lanes provides scalability, redundancy, and high IOPS (input-output operations per second). Multiple lanes allow the artificial intelligence-based hybrid RAID controller device 122 (of FIG. 1) to remain functional and working even in case of failure or errors.

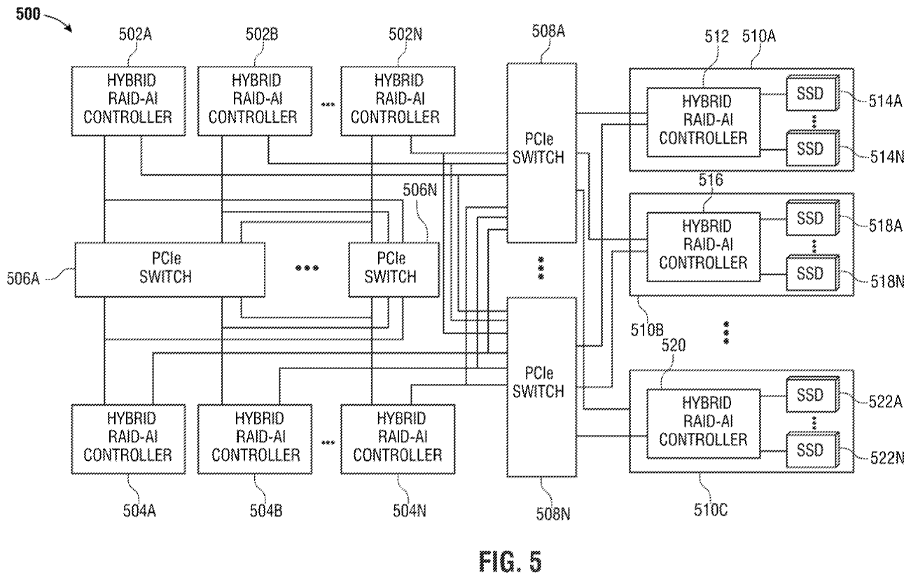

FIG. 5 is a block diagram 500 illustrating an architecture of PCIe switch fabric for messaging in plurality of artificial intelligence-based hybrid RAID controller device 122 (of FIG. 1), in accordance with yet another embodiment of the present disclosure.

Block diagram 500 includes first plurality of artificial intelligence-based hybrid RAID controller devices 502a-502n (shown as hybrid RAID-AI controller in FIG. 5). In addition, block diagram 500 includes second plurality of artificial intelligence-based hybrid RAID controller devices 504a-504n (shown as hybrid RAID-AI controller in FIG. 5). Further, block diagram 500 includes artificial intelligence-based hybrid RAID controller devices 512, 516 and 520 (shown as hybrid RAID-AI controller in FIG. 5).

Furthermore, block diagram 500 includes first plurality of PCIe switch 506a-506n. Moreover, block diagram 500 includes second plurality of PCIe switch 508a-508n. Block diagram 500 includes a plurality of enclosures. The plurality of enclosures includes first enclosure 510a, second enclosure 510b, and third enclosure 510c. Also, block diagram 500 includes first array of SSDs 514a-514n (shown as SSD in FIG. 5), second array of SSDs 518a-518n (shown as SSD in FIG. 5), and third array of SSDs 522a-522n (shown as SSD in FIG. 5).

First enclosure 510a includes the artificial intelligence-based hybrid RAID controller device 512 and the first array of SSDs 514a-514n. The artificial intelligence-based hybrid RAID controller device 512 manages the first array of SSDs 514a-514n. Second enclosure 510b includes the artificial intelligence-based hybrid RAID controller device 516 and the second array of SSDs 518a-518n. The artificial intelligence-based hybrid RAID controller device 516 manages the second array of SSDs 518a-518n. Third enclosure 510c includes the artificial intelligence-based hybrid RAID controller device 520 and the third array of SSDs 522a-522n. The artificial intelligence-based hybrid RAID controller device 520 manages the third array of SSDs 522a-522n.

The first plurality of artificial intelligence-based hybrid RAID controller devices 502a-502n, the second plurality of artificial intelligence-based hybrid RAID controller devices 504a-504n, and the artificial intelligence-based hybrid RAID controller devices 512, 516 and 520 are identical to the artificial intelligence-based hybrid RAID controller device 122 of FIG. 1. The first plurality of PCIe switch 506a-506n and the second plurality of PCIe switch 508a-508n are identical to PCIe switch 204 of FIG. 2. In addition, each of the first array of SSDs 514a-514n, the second array of SSDs 518a-518n, and the third array of SSDs 522a-522n is identical to the array of SSDs 118a-118c.

In an embodiment of the present disclosure, number of the artificial intelligence-based hybrid RAID controller devices 122 (of FIG. 1) in the first plurality of artificial intelligence-based hybrid RAID controller devices 502a-502n and number of the artificial intelligence-based hybrid RAID controller devices 122 (of FIG. 1) in the second plurality of artificial intelligence-based hybrid RAID controller devices 504a-504n may vary.

In an embodiment of the present disclosure, number of PCIe switch in the first plurality of PCIe switch 506a-506n and the second plurality of PCIe switch 508a-508n may vary. In an embodiment of the present disclosure, number of enclosures in plurality of enclosures may vary.

In an embodiment of the present disclosure, number of SSD in the first array of SSDs 514a-514n, the second array of SSDs 518a-518n and the third array of SSDs 522a-522n may vary.

Switch fabric is used as a separate path for messaging and transactions among the first plurality of artificial intelligence-based hybrid RAID controller devices 502a-502n, the second plurality of artificial intelligence-based hybrid RAID controller devices 504a-504n and the artificial intelligence-based hybrid RAID controller devices 512, 516 and 520.

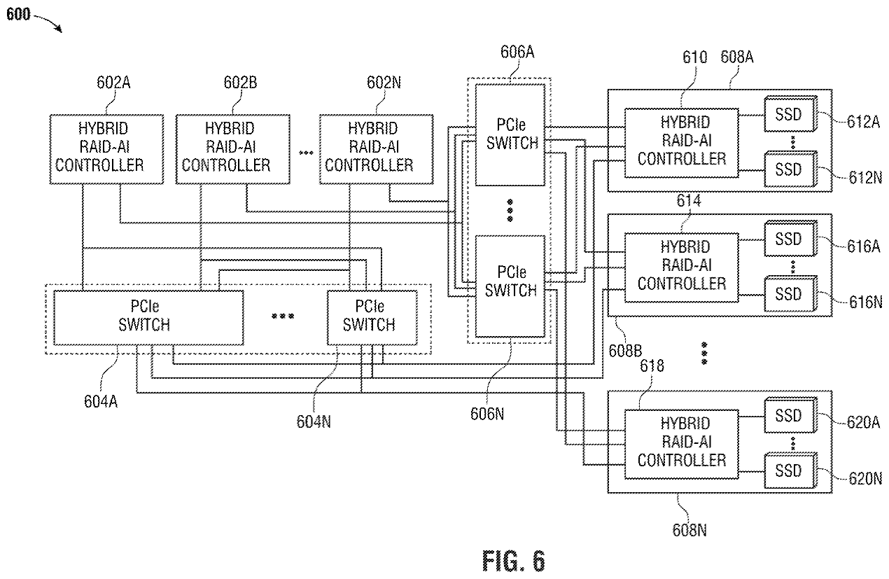

FIG. 6 is a block diagram 600 illustrating an architecture of PCIe switch fabric for messaging in plurality of artificial intelligence-based hybrid RAID controller device 122 (of FIG. 1) with or without plurality of SSDs, in accordance with yet another embodiment of the present disclosure.

Block diagram 600 includes first plurality of artificial intelligence-based hybrid RAID controller devices 602a-602n (shown as hybrid RAID-AI controller in FIG. 6). In addition, block diagram 600 includes artificial intelligence-based hybrid RAID controller devices 610, 614 and 618 (shown as hybrid RAID-AI controller in FIG. 6).

Further, block diagram 600 includes first plurality of PCIe switch 604a-604n. Furthermore, block diagram 600 includes second plurality of PCIe switch 606a-606n. Block diagram 600 includes a plurality of enclosures. The plurality of enclosures include first enclosure 608a, second enclosure 608b, and third enclosure 608n. Also, block diagram 600 includes first array of SSDs 612a-612n (shown as SSD in FIG. 6), second array of SSDs 616a-616n (shown as SSD in FIG. 6), and third array of SSDs 620a-620n (shown as SSD in FIG. 6).

First enclosure 608a includes the artificial intelligence-based hybrid RAID controller device 610 and the first array of SSDs 612a-612n. The artificial intelligence-based hybrid RAID controller device 610 manages the first array of SSDs 612a-612n. Second enclosure 608b includes the artificial intelligence-based hybrid RAID controller device 614 and the second array of SSDs 616a-616n. The artificial intelligence-based hybrid RAID controller device 614 manages the second array of SSDs 616a-616n. Third enclosure 608n includes the artificial intelligence-based hybrid RAID controller device 618 and the third array of SSDs 620a-620n. The artificial intelligence-based hybrid RAID controller device 618 manages the third array of SSDs 620a-620n.

The first plurality of artificial intelligence-based hybrid RAID controller devices 602a-602n, and the artificial intelligence-based hybrid RAID controller devices 610, 614 and 618 are identical to the artificial intelligence-based hybrid RAID controller device 122 of FIG. 1. The first plurality of PCIe switch 604a-604n and the second plurality of PCIe switch 606a-606n are identical to PCIe switch 204 of FIG. 2. In addition, each SSD in the first array of SSDs 612a-612n, the second array of SSDs 616a-616n, and the third array of SSDs 620a-620n is identical to the array of SSDs 118a-118c of FIG. 1.

In an embodiment of the present disclosure, number of the artificial intelligence-based hybrid RAID controller devices 122 (of FIG. 1) in the first plurality of artificial intelligence-based hybrid RAID controller devices 602a-602n may vary.

In an embodiment of the present disclosure, number of PCIe switch in the first plurality of PCIe switch 604a-604n and the second plurality of PCIe switch 606a-606n may vary. In an embodiment of the present disclosure, number of enclosures in plurality of enclosures may vary.

In an embodiment of the present disclosure, number of SSD in the first array of SSDs 612a-612n, the second array of SSDs 616a-616n, and the third array of SSDs 620a-620n may vary.

Switch fabric is used as a separate path for messaging and transactions between the first plurality of artificial intelligence-based hybrid RAID controller devices 602a-602n, and the artificial intelligence-based hybrid RAID controller devices 610, 614 and 618.

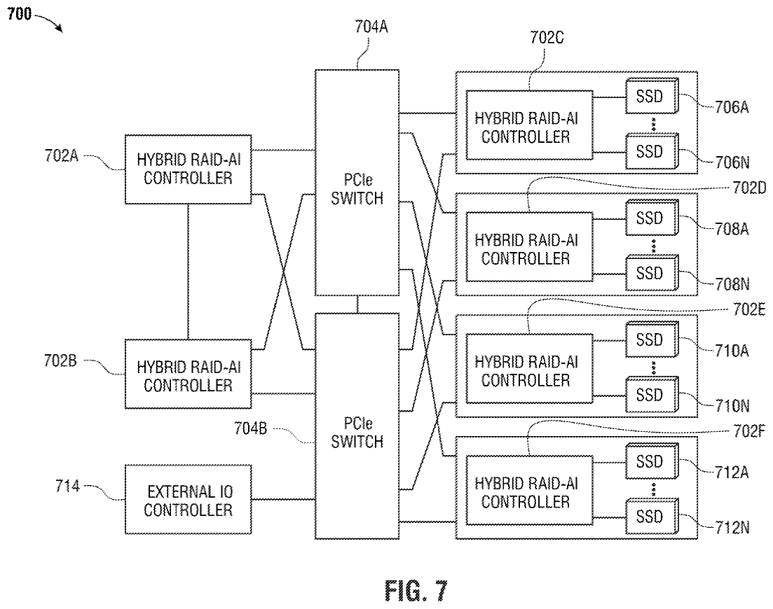

FIG. 7 is a block diagram 700 illustrating a storage system with multi-level SSD RAID topology using the artificial intelligence-based hybrid RAID controller device 122 (of FIG. 1) and an external IO controller 714, in accordance with yet another embodiment of the present disclosure.

Block diagram 700 includes artificial intelligence-based hybrid RAID controller devices 702a-702f (shown as hybrid RAID-AI controller in FIG. 7). In addition, block diagram 700 includes PCIe switch 704a, PCIe switch 704b, and a plurality of array of SSDs. The plurality of array of SSDs includes first array of SSDs 706a-706n (shown as SSD in FIG. 7), second array of SSDs 708a-708n (shown as SSD in FIG. 7), third array of SSDs 710a-710n (shown as SSD in FIG. 7), and fourth array of SSDs 712a-712n (shown as SSD in FIG. 7). Block diagram 700 includes the external IO controller 714.

The artificial intelligence-based hybrid RAID controller devices 702a-702f are identical to the artificial intelligence-based hybrid RAID controller device 122 of FIG. 1. PCIe switch 704a is identical to PCIe switch 204 of FIG. 2. PCIe switch 704b is identical to PCIe switch 204 of FIG. 2. In addition, each of the plurality of array of SSDs is identical to SSD in the array of SSDs 118a-118c of FIG. 1.

In an embodiment of the present disclosure, number of SSD in the first array of SSDs 706a-706n, the second array of SSDs 708a-708n, the third array of SSDs 710a-710n, and the fourth array of SSDs 712a-712n may vary.

The external IO controller 714 is used to connect to the artificial intelligence-based hybrid RAID controller devices 702a-702f using one or more interfaces. The external IO controller 714 is identical to the external IO controller 304 of FIG. 3.

In one example, the external IO controller 714 is connected with the artificial intelligence-based hybrid RAID controller devices 702c-702f using SAS interface. In another example, the external IO controller 714 is connected with the artificial intelligence-based hybrid RAID controller devices 702c-702f using PCIe interface. In yet another example, the external IO controller 714 is connected with the artificial intelligence-based hybrid RAID controller devices 702c-702f using FC interface. In yet another example, the external IO controller 714 is connected with the artificial intelligence-based hybrid RAID controller devices 702c-702f using Ethernet interface.

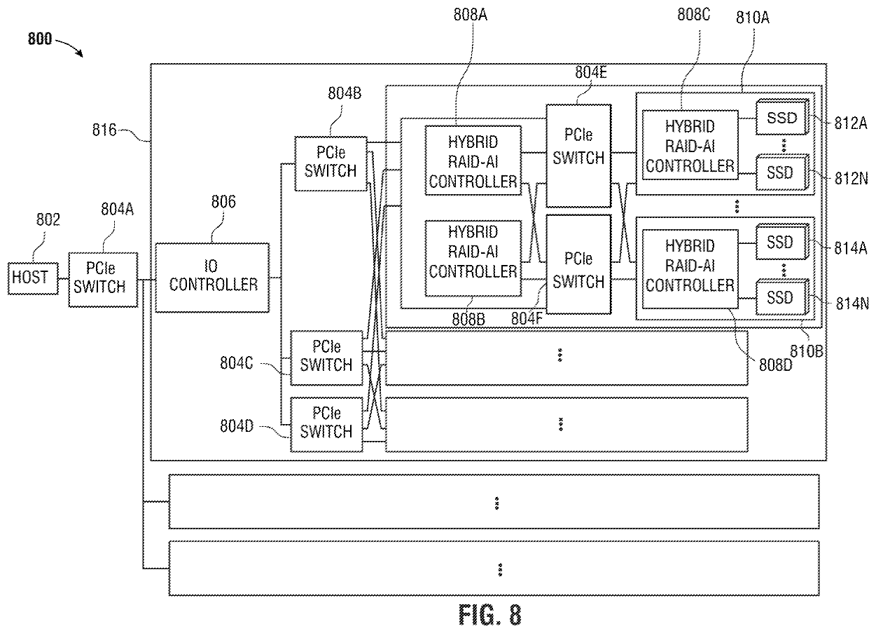

FIG. 8 is a block diagram 800 illustrating a scaled version of multi-level SSD RAID topology using the artificial intelligence-based hybrid RAID controller device 122 (of FIG. 1) interconnected with switch fabric and an IO controller 806, in accordance with yet another embodiment of the present disclosure.

Block diagram 800 includes host 802, PCIe switch 804a-804f, and the IO controller 806. Block diagram 800 includes artificial intelligence-based hybrid RAID controller devices 808a-808d (shown as hybrid RAID-AI controller in FIG. 8), plurality of enclosures, first array of SSDs 812a-812n (shown as SSD in FIG. 8), second array of SSDs 814a-814n (shown as SSD in FIG. 8), and a unit 816. The plurality of enclosures includes a first enclosure 810a and a second enclosure 810b.

First enclosure 810a includes the artificial intelligence-based hybrid RAID controller device 808c and the first array of SSDs 812a-812n. The artificial intelligence-based hybrid RAID controller device 808c manages the first array of SSDs 812a-812n. Second enclosure 810b includes the artificial intelligence-based hybrid RAID controller device 808d and the second array of SSDs 814a-814n. The artificial intelligence-based hybrid RAID controller device 808d manages the second array of SSDs 814a-814n.

The host 802 is identical to the host 202 of FIG. 2. The IO controller 806 is identical to the external IO controller 304 of FIG. 3. The artificial intelligence-based hybrid RAID controller devices 808a-808d are identical to the artificial intelligence-based hybrid RAID controller device 122 of FIG. 1. PCIe switch 804a-804d are identical to PCIe switch 204 of FIG. 2. In addition, each SSD in the first array of SSDs 812a-812n and the second array of SSDs 814a-814n is identical to SSD of the array of SSDs 118a-118c (of FIG. 1).

In an embodiment of the present disclosure, number of enclosures in plurality of enclosures may vary. In an embodiment of the present disclosure, number of SSD in the first array of SSDs 812a-812n, and the second array of SSDs 814a-814n may vary.

Unit 816 encloses various components of block diagram 800 (as shown in FIG. 8). In an embodiment of the present disclosure, unit 816 encloses various components of block diagram 800 in 3 unit form factor. In another embodiment of the present disclosure, unit 816 encloses various components of block diagram 800 in any other form factor of the like. In an embodiment of the present disclosure, number of unit 816 in block diagram 800 may vary. Further, block diagram 800 includes multiple of unit 816 and the multiple of unit 816 are interconnected using multiple connections (as shown in FIG. 8).

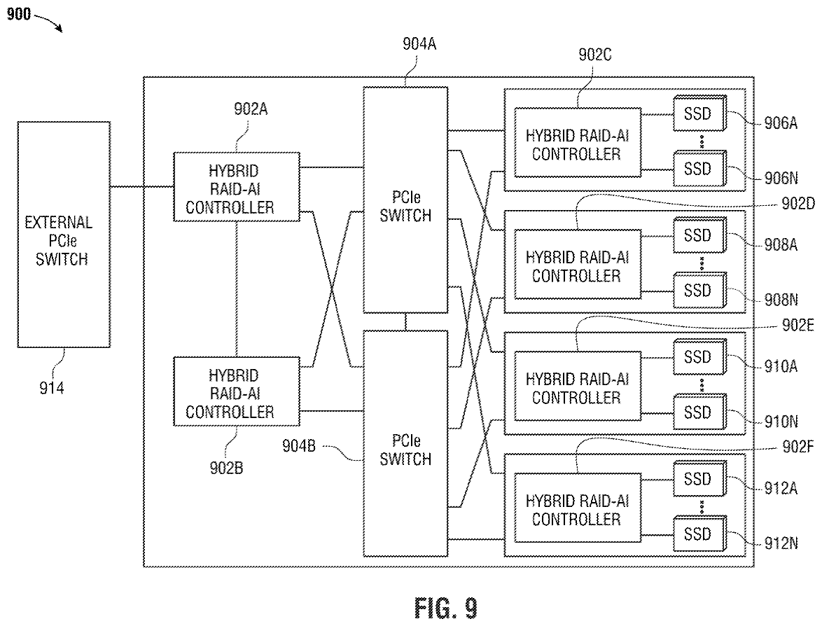

FIG. 9 is a block diagram 900 illustrating the artificial intelligence-based hybrid RAID controller device 122 (of FIG. 1) as a bridge in multi-level SSD RAID topology to connect external PCIe switch, in accordance with yet another embodiment of the present disclosure. Bridge is device that provides interconnection with other devices.

Block diagram 900 includes artificial intelligence-based hybrid RAID controller devices 902a-902f (shown as hybrid RAID-AI controller in FIG. 9). In addition, block diagram 900 includes PCIe switch 904a, PCIe switch 904b, and a plurality of array of SSDs. The plurality of array of SSDs includes first array of SSDs 906a-906n (shown as SSD in FIG. 9), second array of SSDs 908a-908n (shown as SSD in FIG. 9), third array of SSDs 910a-910n (shown as SSD in FIG. 9), and fourth array of SSDs 912a-912n (shown as SSD in FIG. 9). Block diagram 900 includes an external PCIe switch 914.

The artificial intelligence-based hybrid RAID controller devices 902a-902f are identical to the artificial intelligence-based hybrid RAID controller device 122 of FIG. 1. PCIe switch 904a is identical to PCIe switch 204 of FIG. 2. PCIe switch 904b is identical to PCIe switch 204 of FIG. 2. In addition, each of the plurality of array of SSDs is identical to SSD of the array of SSDs 118a-118c (of FIG. 1). External PCIe switch 914 is identical to PCIe switch 204 of FIG. 2.

In an embodiment of the present disclosure, number of SSD in the first array of SSDs 906a-906n, the second array of SSDs 908a-908n, the third array of SSDs 910a-910n, and the fourth array of SSDs 912a-912n may vary.

External PCIe switch 914 acts as a bridge to connect the artificial intelligence-based hybrid RAID controller devices 902a-902f in multi-level SSD RAID topology (as shown in FIG. 9).

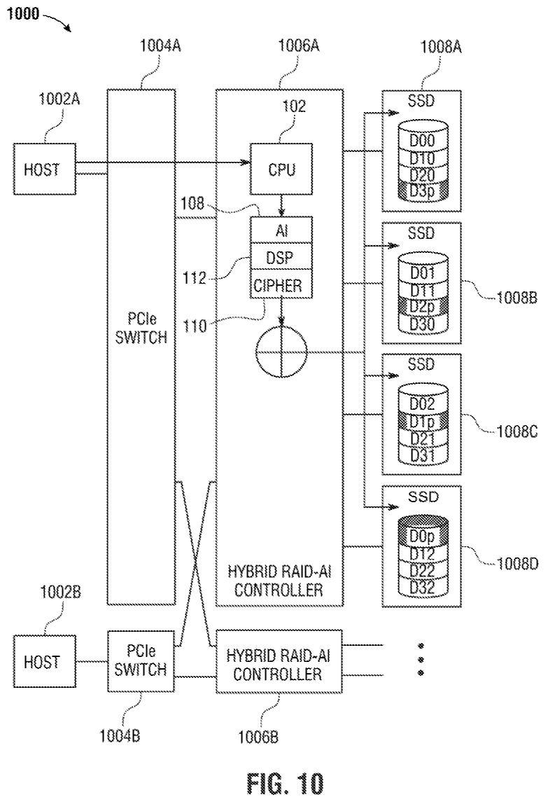

FIG. 10 is a block diagram 1000 illustrating RAID implementation in the artificial intelligence-based hybrid RAID controller device 122 (of FIG. 1) along with an option to perform encryption and/or DSP processing for artificial intelligence, in accordance with an embodiment of the present disclosure.

Block diagram 1000 includes host 1002a, host 1002b, PCIe switch 1004a, PCIe switch 1004b, artificial intelligence-based hybrid RAID controller device 1006a (shown as hybrid RAID-AI controller in FIG. 10), artificial intelligence-based hybrid RAID controller device 1006b (shown as hybrid RAID-AI controller in FIG. 10), and array of SSDs 1008a-1008d (shown as SSD in FIG. 10).

Block diagram 1000 includes the CPU 102 (of FIG. 1), the artificial intelligence inference engine module 108 (shown as AI in FIG. 10), the DSP module 112 (shown as DSP in FIG. 10), and the XOR/Cipher engine module 110 (shown as Cipher in FIG. 10). In an embodiment of the present disclosure, the artificial intelligence-based hybrid RAID controller device 1006a utilizes the artificial intelligence inference engine module 108, the DSP module 112 and the XOR/Cipher engine module 110 interchangeably in any order.

The host 1002a is identical to the host 202 of FIG. 2. The host 1002b is identical to the host 202 of FIG. 2. PCIe switch 1004a, 1004b are identical to PCIe switch 204 of FIG. 2. The artificial intelligence-based hybrid RAID controller devices 1006a, 1006b are identical to the artificial intelligence-based hybrid RAID controller device 122 of FIG. 1. In addition, each of the array of SSDs 1008a-1008d is identical to SSD of the array of SSDs 118a-118c of FIG. 1. In an embodiment of the present disclosure, number of SSD in the array of SSDs 1008a-1008d may vary. In an embodiment of the present disclosure, number of the CPU 102, the artificial intelligence inference engine module 108, the DSP module 112 and the XOR/Cipher engine module 110 may vary.

The artificial intelligence-based hybrid RAID controller device 1006a performs RAID implementation (as explained in FIG. 1) at SSD level. In addition, the artificial intelligence-based hybrid RAID controller device 1006a performs encryption and DSP processing for artificial intelligence inference. Further, the set of data blocks and the parity block corresponding to each RAID data stripe are stored in the array of SSDs 1008a-1008d connected to the artificial intelligence-based hybrid RAID controller device 1006a (as shown in FIG. 10).

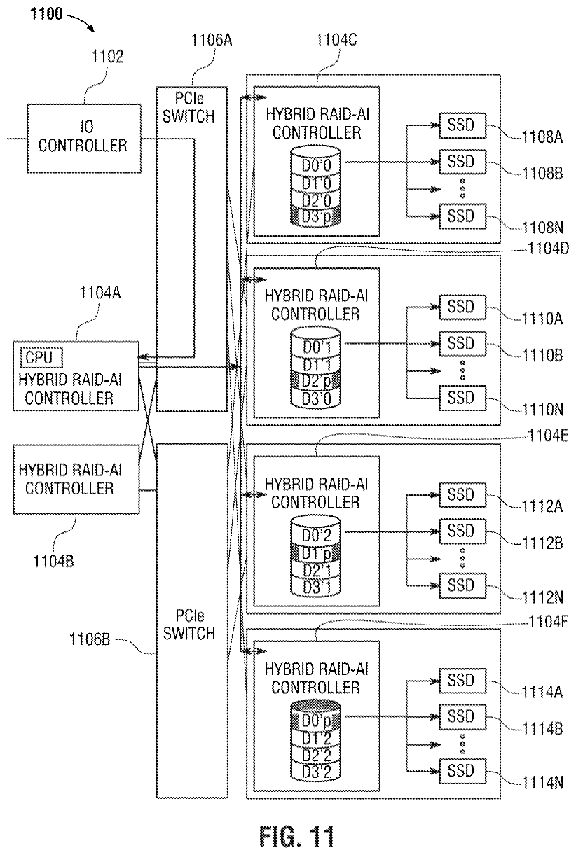

FIG. 11 is a block diagram 1100 illustrating multi-level RAID implementation with facilitation of the artificial intelligence-based hybrid RAID controller device 122 (of FIG. 1), in accordance with another embodiment of the present disclosure.

Block diagram 1100 includes an IO controller 1102, artificial intelligence-based hybrid RAID controller devices 1104a-1104f (shown as hybrid RAID-AI controller in FIG. 11), PCIe switch 1106a, and PCIe switch 1106b. In addition, block diagram 1100 includes plurality of array of SSDs. The plurality of array of SSDs include first array of SSDs 1108a, 1108b-1108n, second array of SSDs 1110a, 1110b-1110n, third array of SSDs 1112a, 1112b-1112n, and fourth array of SSDs 1114a, 1114b-1114n.

In an embodiment of the present disclosure, number of SSD in the first array of SSDs 1108a, 1108b-1108n, the second array of SSDs 1110a, 1110b-1110n, the third array of SSDs 1112a, 1112b-1112n, and the fourth array of SSDs 1114a, 1114b-1114n may vary. The IO controller 1102 is identical to the external IO controller 304 of FIG. 3.

The artificial intelligence-based hybrid RAID controller device 1104c manages the first array of SSDs 1108a, 1108b-1108n. The artificial intelligence-based hybrid RAID controller device 1104d manages the second array of SSDs 1110a, 1110b-1110n. The artificial intelligence-based hybrid RAID controller device 1104e manages the third array of SSDs 1112a, 1112b-1112n. The artificial intelligence-based hybrid RAID controller device 1104f manages the fourth array of SSDs 1114a, 1114b-1114n.

The artificial intelligence-based hybrid RAID controller devices 1104a-1104b performs RAID implementation (as explained in FIG. 1) by storing RAID data stripe across each of the artificial intelligence-based hybrid RAID controller devices 1104c-1104f. Further, each of the artificial intelligence-based hybrid RAID controller devices 1104c-1104f perform RAID implementation by storing data stripe across the plurality of array of SSDs managed by each of the artificial intelligence-based hybrid RAID controller devices 1104c-1104f respectively (as shown in FIG. 11).

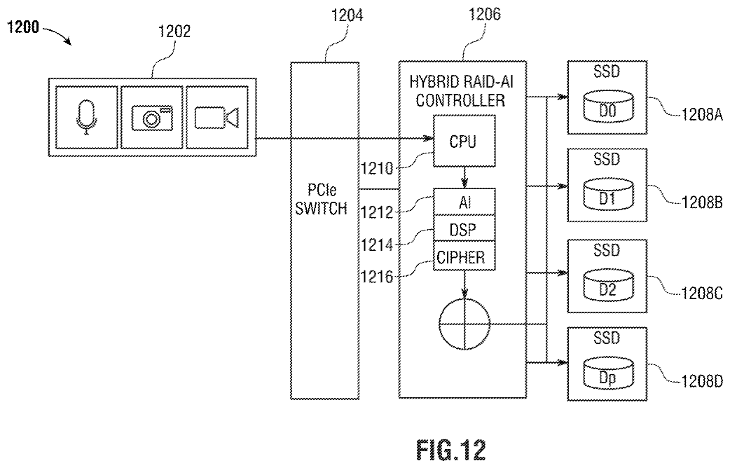

FIG. 12 is a block diagram 1200 illustrating the artificial intelligence-based hybrid RAID controller device 122 (of FIG. 1) performing input processing with an option to perform encryption, DSP processing and/or artificial intelligence processing with RAID, in accordance with yet another embodiment of the present disclosure.

Block diagram 1200 includes an input 1202, PCIe switch 1204, and an artificial intelligence-based hybrid RAID controller device 1206 (shown as hybrid RAID-AI controller in FIG. 7). In addition, block diagram 1200 includes array of SSDs 1208a-1208d. Further, block diagram 1200 includes CPU 1210, an artificial intelligence inference engine module 1212 (shown as AI in FIG. 12), DSP module 1214 (shown as DSP in FIG. 12) and XOR/Cipher engine module 1216 (shown as Cipher in FIG. 12). Each of the array of SSDs 1208a-1210d is identical to SSD of the array of SSDs 118a-118c (of FIG. 1). In an embodiment of the present disclosure, number of SSD in the array of SSDs 1208a-1208d may vary.

PCIe switch 1204 is identical to PCIe switch 204 of FIG. 2. The artificial intelligence-based hybrid RAID controller device 1206 is identical to the artificial intelligence-based hybrid RAID controller device 122 of FIG. 1. The CPU 1210 is identical to the CPU 102 of FIG. 1. The artificial intelligence inference engine module 1212 is identical to the artificial intelligence inference engine module 108 of FIG. 1. In an embodiment of the present disclosure, number of the CPU 1210, the artificial intelligence inference engine module 1212, the DSP module 1214 and the XOR/Cipher engine module 1216 may vary.

The DSP module 1214 is identical to the DSP module 112 of FIG. 1. The XOR/Cipher engine module 1216 is identical to the XOR/Cipher engine module 110 of FIG. 1. In one example, input 1202 is received from the host 202 of FIG. 2. In another example, input 1202 is received from an external source or environment. In yet another example, input 1202 is a real-time image captured from a camera device. In yet another example, input 1202 is a real-time video stream received from a camera device. In yet another example, input 1202 is real-time audio coming from speaker. However, input 1202 is not limited to above-mentioned input sources.

Input 1202 is received in variety of formats such as audio format, image format, video format, animation format, gif format, text format, or any other similar format.

In an example, input 1202 includes sound coming from physical world and outside environment. In another example, input 1202 includes view of the outside world or surrounding. In yet another example, input 1202 includes video stream coming from the outside world or surrounding.

The artificial intelligence-based hybrid RAID controller device 1206 receives input 1202. Further, the CPU 1210 processes input 1202. The CPU 1210 employs the artificial intelligence inference engine module 1212 to run deep learning neural networks to process input 1202. Furthermore, the array of SSDs 1208a-1208d are utilized to store newly learned data. Moreover, the array of SSDs 1208a-1208d are utilized to retrieve already stored data for comparison. Data moves to or from the array of SSDs 1208a-1208d to the SRAM 104 (of FIG. 1) and the DRAM 106 (of FIG. 1). In addition, the artificial intelligence inference engine module 1212 utilizes the array of SSDs 1208a-1208d to retrieve data. Also, the CPU 1210 initially stores data to the SRAM 104 and the DRAM 106 before and after performing computation. The artificial intelligence-based hybrid RAID controller device 1206 provides real-time insights and tactical decision-making based on the processing of received input 1202 (as explained above in FIG. 1).

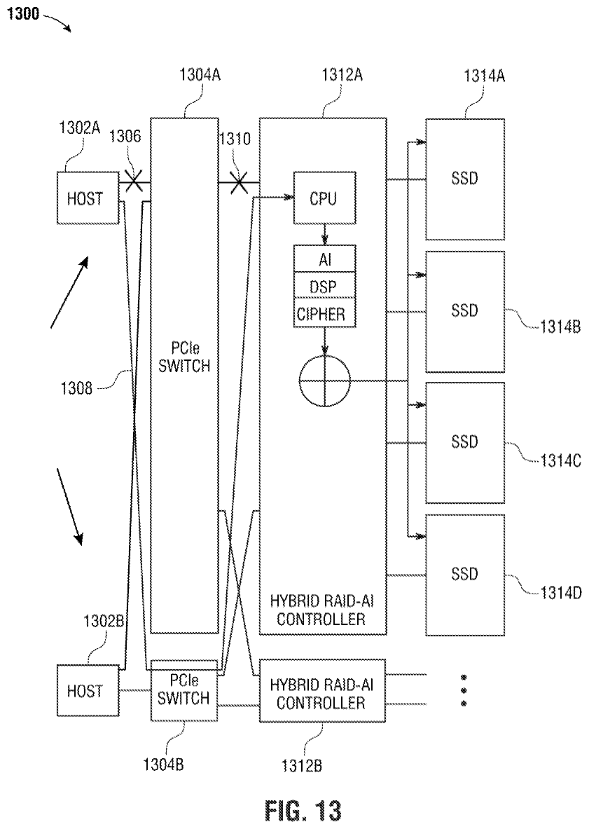

FIG. 13 is a schematic block diagram 1300 illustrating the artificial intelligence-based hybrid RAID controller device 122 (of FIG. 1) recovering data in case of interconnect failure, in accordance with an embodiment of the present disclosure.

Schematic block diagram 1300 includes host 1302a, host 1302b, PCIe switch 1304a and PCIe switch 1304b. In addition, schematic block diagram 1300 includes artificial intelligence-based hybrid RAID controller devices 1312a, 1312b (shown as hybrid RAID-AI controller in FIG. 13) and array of SSDs 1314a-1314d (shown as SSD in FIG. 13). Further, schematic block diagram 1300 includes x 1306, interconnect 1308, and x 1310. Each of the array of SSDs 1314a-1314d is identical to SSD of the array of SSDs 118a-118c (of FIG. 1). In an embodiment of the present disclosure, number of SSD in the array of SSDs 1314a-1314d may vary.

The host 1302a is identical to the host 202 of FIG. 2. The host 1302b is identical to the host 202 of FIG. 2. PCIe switch 1304a is identical to PCIe switch 204 of FIG. 2. PCIe switch 1304b is identical to PCIe switch 204 of FIG. 2. The artificial intelligence-based hybrid RAID controller device 1312a is identical to the artificial intelligence-based hybrid RAID controller device 122 of FIG. 1. The artificial intelligence-based hybrid RAID controller device 1312b is identical to the artificial intelligence-based hybrid RAID controller device 122 of FIG. 1. In an embodiment of the present disclosure, number of the CPU 102 (of FIG. 1), the artificial intelligence inference engine module 108 (of FIG. 1), the DSP module 112 of FIG. 1 and the XOR/Cipher engine module 110 of FIG. 1 may vary.

In an embodiment of the present disclosure, the artificial intelligence-based hybrid RAID controller device 122 of FIG. 1 replaces the host 1302a (in FIG. 13). In an embodiment of the present disclosure, the artificial intelligence-based hybrid RAID controller device 122 of FIG. 1 replaces the host 1302b (in FIG. 13).

X 1306 denotes failure in the connection between the host 1302a and PCIe switch 1304a. X 1310 denotes failure in the connection between PCIe switch 1304a and the artificial intelligence-based hybrid RAID controller device 1312a. In an embodiment of the present disclosure, mechanical failure of interconnect lanes causes failure. The host 1302a sends data through interconnect 1308 to the CPU 102 of the artificial intelligence-based hybrid RAID controller device 1312a.

In case of interconnect failure, the artificial intelligence-based hybrid RAID controller devices 1312a, 1312b provides data redundancy and data recovery through multiple interconnections (as shown in FIG. 13).

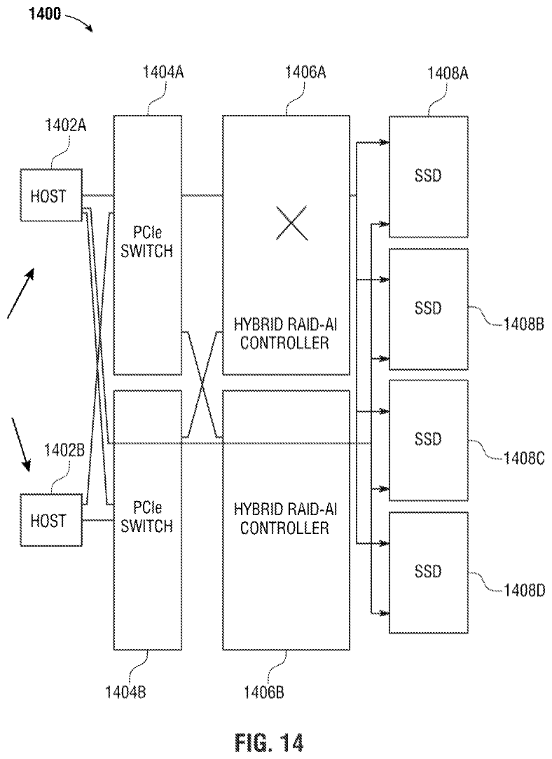

FIG. 14 is a schematic block diagram 1400 illustrating the artificial intelligence-based hybrid RAID controller device 122 (of FIG. 1) recovering data in case of failure of the artificial intelligence-based hybrid RAID controller device 122 (of FIG. 1), in accordance with another embodiment of the present disclosure.

Schematic block diagram 1400 includes host 1402a, host 1402b, PCIe switch 1404a and PCIe switch 1404b. In addition, schematic block diagram 1400 includes artificial intelligence-based hybrid RAID controller device 1406a, 1406b (shown as hybrid RAID-AI controller in FIG. 14) and array of SSDs 1408a-1408d (shown as SSD in FIG. 14). Each of the array of SSDs 1408a-1408d is identical to SSD of the array of SSDs 118a-118c (of FIG. 1). In an embodiment of the present disclosure, number of SSD in the array of SSDs 1408a-1408d may vary.

The host 1402a is identical to the host 202 of FIG. 2. The host 1402b is identical to the host 202 of FIG. 2. PCIe switch 1404a is identical to PCIe switch 204 of FIG. 2. PCIe switch 1404b is identical to PCIe switch 204 of FIG. 2. The artificial intelligence-based hybrid RAID controller device 1406a is identical to the artificial intelligence-based hybrid RAID controller device 122 of FIG. 1. The artificial intelligence-based hybrid RAID controller device 1406b is identical to the artificial intelligence-based hybrid RAID controller device 122 of FIG. 1.

In an embodiment of the present disclosure, the artificial intelligence-based hybrid RAID controller device 122 of FIG. 1 replaces the host 1402a (in FIG. 14). In an embodiment of the present disclosure, the artificial intelligence-based hybrid RAID controller device 122 of FIG. 1 replaces the host 1402b (in FIG. 14).

The x denotes failure of the artificial intelligence-based hybrid RAID controller device 1406a. In an embodiment of the present disclosure, mechanical wear and tear of the artificial intelligence-based hybrid RAID controller device 1406a causes failure. The host 1402a wants to access data stored in the array of SSDs 1408a-1408d. The artificial intelligence-based hybrid RAID controller device 1406b allows the host 1402a to use redundant paths to access data stored in the array of SSDs 1408a-1408d. In case the artificial intelligence-based hybrid RAID controller device 1406a fails, then the artificial intelligence-based hybrid RAID controller device 1406b provides data redundancy and data recovery (as shown in FIG. 14).

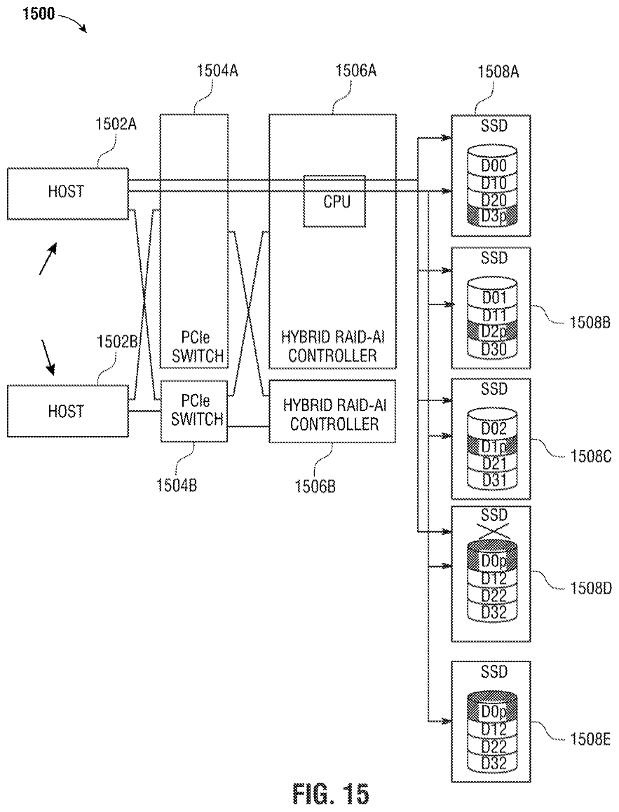

FIG. 15 is a schematic block diagram 1500 illustrating the artificial intelligence-based hybrid RAID controller device 122 (of FIG. 1) recovering data in case of failure of SSD, in accordance with yet another embodiment of the present disclosure.

Schematic block diagram 1500 includes host 1502a, host 1502b, PCIe switch 1504a and PCIe switch 1504b. In addition, schematic block diagram 1500 includes artificial intelligence-based hybrid RAID controller devices 1506a, 1506b (shown as hybrid RAID-AI controller in FIG. 15) and array of SSDs 1508a-1508e (shown as SSD in FIG. 15). In an embodiment of the present disclosure, number of SSD in the array of SSDs 1508a-1508e may vary.

The host 1502a is identical to the host 202 of FIG. 2. The host 1502b is identical to the host 202 of FIG. 2. PCIe switch 1504a is identical to PCIe switch 204 of FIG. 2. PCIe switch 1504b is identical to PCIe switch 204 of FIG. 2. The artificial intelligence-based hybrid RAID controller device 1506a is identical to the artificial intelligence-based hybrid RAID controller device 122 of FIG. 1. The artificial intelligence-based hybrid RAID controller device 1506b is identical to the artificial intelligence-based hybrid RAID controller device 122 of FIG. 1. Each of the array of SSDs 1508a-1508d is identical to SSD of the array of SSDs 118a-118c of FIG. 1. In an embodiment of the present disclosure, number of the CPU 102 (of FIG. 1) may vary.

In an embodiment of the present disclosure, the artificial intelligence-based hybrid RAID controller device 122 of FIG. 1 replaces the host 1502a (in FIG. 15). In an embodiment of the present disclosure, the artificial intelligence-based hybrid RAID controller device 122 of FIG. 1 replaces the host 1502b (in FIG. 15).

The x denotes failure of SSD 1508d. In an embodiment of the present disclosure, mechanical wear and tear of SSD 1508D causes failure. The host 1502a wants to access data stored in SSD 1508d. The artificial intelligence-based hybrid RAID controller device 1506a utilizes RAID implementation (as explained above in FIG. 1) to perform data redundancy and access stored similar data in SSDs 1508a, 1508b, and 1508c. In addition, the artificial intelligence-based hybrid RAID controller device 1506a utilizes RAID implementation to recreate data in SSD 1508d using stored similar data in SSDs 1508a, 1508b, and 1508c.

Further, SSD 1508e stores recreated data. The artificial intelligence-based hybrid RAID controller device 1506a allows the host 1502a to access recreated data in SSD 1508e. In case of failure of SSD 1508d, SSDs 1508a, 1508b and 1508c provides data redundancy and data recovery through RAID implementation (as shown in FIG. 15).

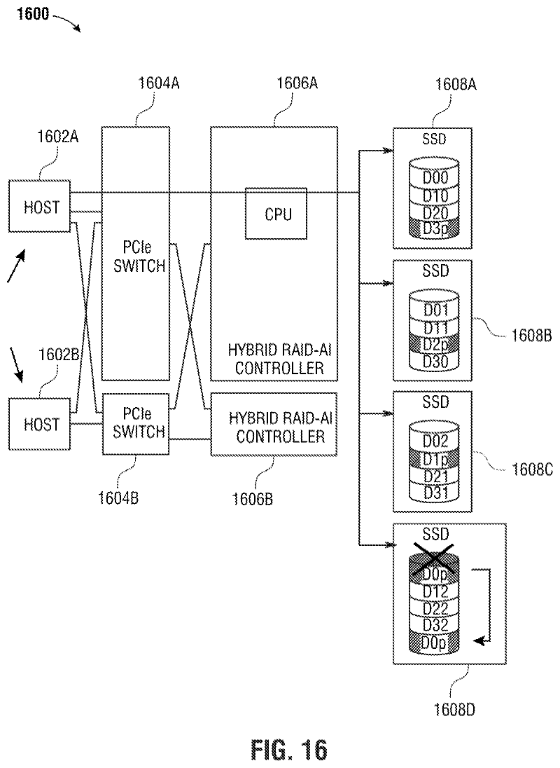

FIG. 16 is a schematic block diagram 1600 illustrating the artificial intelligence-based hybrid RAID controller device 122 (of FIG. 1) recovering data in case of failure of RAID stripe in SSD, in accordance with yet another embodiment of the present disclosure.

Schematic block diagram 1600 includes host 1602a, host 1602b, PCIe switch 1604a and PCIe switch 1604b. In addition, schematic block diagram 1600 includes artificial intelligence-based hybrid RAID controller devices 1606a, 1606b (shown as hybrid RAID-AI controller in FIG. 16) and array of SSDs 1608a-1608d (shown as SSD in FIG. 16). In an embodiment of the present disclosure, number of SSD in the array of SSDs 1608a-1608d may vary.

The host 1602a is identical to the host 202 of FIG. 2. The host 1602b is identical to the host 202 of FIG. 2. PCIe switch 1604a is identical to PCIe switch 1604 of FIG. 2. PCIe switch 1604b is identical to PCIe switch 204 of FIG. 2. The artificial intelligence-based hybrid RAID controller device 1606a is identical to the artificial intelligence-based hybrid RAID controller device 122 of FIG. 1. The artificial intelligence-based hybrid RAID controller device 1606b is identical to the artificial intelligence-based hybrid RAID controller device 122 of FIG. 1. Each of the array of SSDs 1608a-1608d is identical to SSD of the array of SSDs 118a-118c of FIG. 1. In an embodiment of the present disclosure, number of the CPU 102 (of FIG. 1) may vary.

In an embodiment of the present disclosure, the artificial intelligence-based hybrid RAID controller device 122 of FIG. 1 replaces the host 1602a (in FIG. 16). In an embodiment of the present disclosure, the artificial intelligence-based hybrid RAID controller device 122 of FIG. 1 replaces the host 1602b (in FIG. 16).

The x denotes failure of data in SSD 1608d. The x denotes failure in some part of SSD 1608d and not entire SSD 1608d. In an embodiment of the present disclosure, power failure or corrupt data in SSD 1608d causes failure. The host 1602a wants to access data stored in SSD 1608d. The artificial intelligence-based hybrid RAID controller device 1606a utilizes RAID implementation (as explained above in FIG. 1) to perform data recovery and access similar data stored in other RAID stripes of SSDs 1608a-1608c. In addition, the artificial intelligence-based hybrid RAID controller device 1606a utilizes RAID implementation to recreate data in SSD 1608d using stored similar data in SSDs 1608a, 1608b, and 1608c. Further, SSD 1608d stores recreated data.

The artificial intelligence-based hybrid RAID controller device 1606a allows the host 1602a to access data stored in SSD 1608d using RAID implementation. In case of failure of RAID stripe in SSD 1608d, The artificial intelligence-based hybrid RAID controller devices 1606a, 1606b provides data redundancy and data recovery through RAID implementation (as shown in FIG. 16).

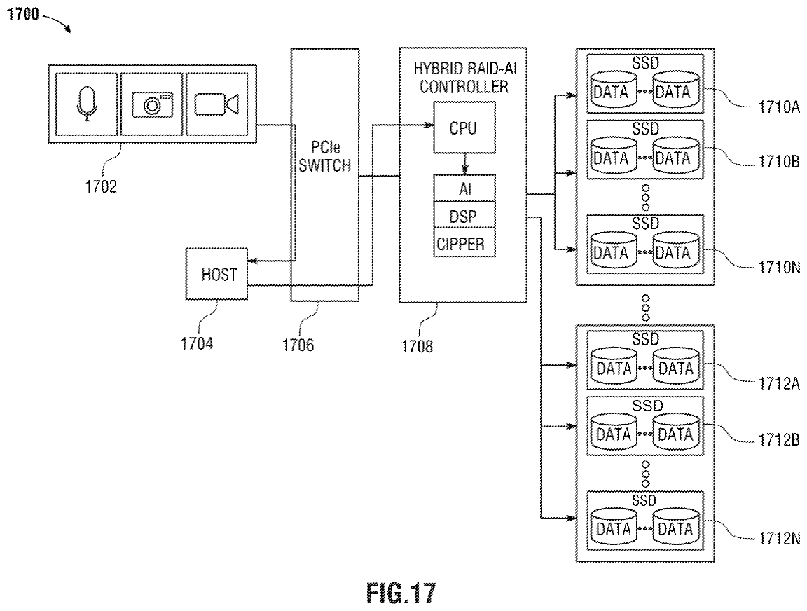

FIG. 17 is a schematic block diagram 1700 of the artificial intelligence-based hybrid RAID controller device 122 (of FIG. 1) performing single AI processing using the artificial intelligence inference engine module 108 (of FIG. 1) and the DSP module 112 (of FIG. 1), in accordance with an embodiment of the present disclosure.

Schematic block diagram 1700 includes an input 1702, host 1704, PCIe switch 1706, and an artificial intelligence-based hybrid RAID controller device 1708 (shown as hybrid RAID-AI controller in FIG. 17). The host 1704 is identical to host 202 (of FIG. 2). In addition, schematic block diagram 1700 includes first array of SSDs 1710a-1710n (shown as SSD in FIG. 17). Further, schematic block diagram 1700 includes second array of SSDs 1712a-1712n (shown as SSD in FIG. 17). In an embodiment of the present disclosure, number of SSD in the first array of SSDs 1710a-1710n, and the second array of SSDs 1712a-1712n may vary.

The artificial intelligence-based hybrid RAID controller device 1708 includes CPU, artificial intelligence inference engine module (shown as AI in FIG. 17), DSP module (shown as DSP in FIG. 17) and XOR/Cipher engine module (shown as Cipher in FIG. 17) (as shown in FIG. 17).

PCIe switch 1706 is identical to PCIe switch 204 of FIG. 2. The artificial intelligence-based hybrid RAID controller device 1708 is identical to the artificial intelligence-based hybrid RAID controller device 122 of FIG. 1. CPU is identical to the CPU 102 of FIG. 1. Artificial intelligence inference engine module is identical to the artificial intelligence inference engine module 108 of FIG. 1.

DSP module is identical to the DSP module 112 of FIG. 1. XOR/Cipher engine module is identical to the XOR/Cipher engine module 110 of FIG. 1. In an embodiment of the present disclosure, number of the CPU 102 (of FIG. 1), the artificial intelligence inference engine module 108 (of FIG. 1), the DSP module 112 of FIG. 1 and the XOR/Cipher engine module 110 of FIG. 1 may vary. In one example, the host 1704 receives input 1702 using PCIe switch 1706. In another example, input 1702 is received from an external source or surrounding. In yet another example, input 1702 is received from input device.

Input 1702 is received in variety of formats, such as audio format, image format, video format, animation format, gif format, text format, or any other similar format.

In an example, input 1702 includes sound coming from speaker or physical world and outside environment. In another example, input 1702 includes a real-time view of the outside world or surrounding captured through a camera. In yet another example, input 1702 includes a real-time video stream coming from the outside world or surrounding captured through a video camera.

The host 1704 utilizes PCIe switch 1706 to send input 1702 to the artificial intelligence-based hybrid RAID controller device 1708. Further, the CPU 102 (of FIG. 1) sets up DMA to transfer input 1702. DMA stands for Direct Memory Access. DMA provides ability to input-output devices to access memory without use of the CPU 102 (of FIG. 1). DMA allows streaming of input 1702 from input device to PCIe switch 1706 and the artificial intelligence-based hybrid RAID controller device 1708. In addition, the artificial intelligence-based hybrid RAID controller device 1708 utilizes number of the artificial intelligence inference engine module 108 (of FIG. 1), the DSP module 112 of FIG. 1 and the XOR/Cipher engine module 110 of FIG. 1 to perform faster computing operations. The artificial intelligence-based hybrid RAID controller device 1708 provides real-time insights and tactical decision-making based on the processing of received input 1702 (as explained above in FIG. 1) (as shown in FIG. 17).

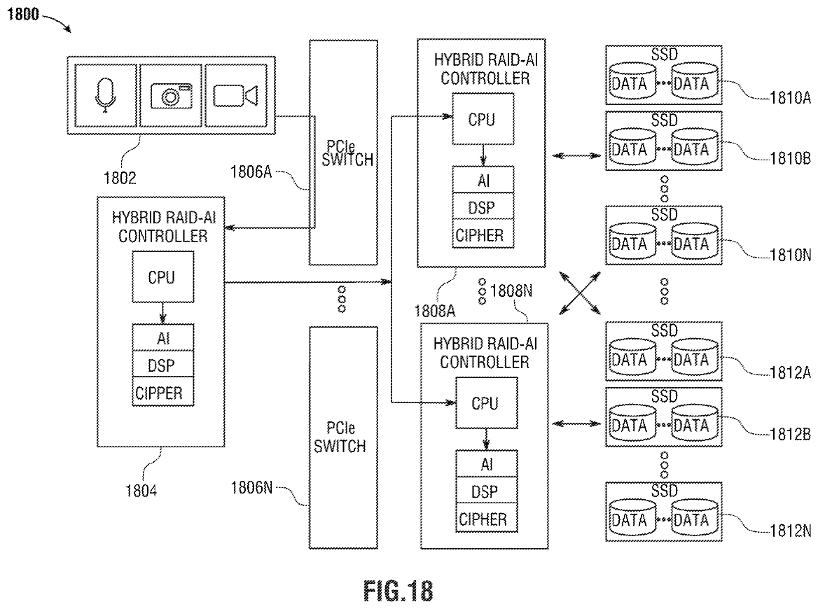

FIG. 18 is a schematic block diagram 1800 of plurality of the artificial intelligence-based hybrid RAID controller device 122 (of FIG. 1) performing distributed AI processing using the artificial intelligence inference engine module 108 (of FIG. 1) and the DSP modules 112 (of FIG. 1) of the respective artificial intelligence-based hybrid RAID controller devices, in accordance with another embodiment of the present disclosure.

Schematic block diagram 1800 includes an input 1802, artificial intelligence-based hybrid RAID controller device 1804 (shown as hybrid RAID-AI controller in FIG. 18), plurality of PCIe switch 1806a-1806n, plurality of artificial intelligence-based hybrid RAID controller devices 1808a-1808n (shown as hybrid RAID-AI controller in FIG. 18). In addition, schematic block diagram 1800 includes first array of SSDs 1810a-1810n (shown as SSD in FIG. 18). Further, schematic block diagram 1800 includes second array of SSDs 1812a-1812n (shown as SSD in FIG. 18).

In an embodiment of the present disclosure, number of PCIe switch in the plurality of PCIe switch 1806a-1806n may vary. In an embodiment of the present disclosure, number of the artificial intelligence-based hybrid RAID controller devices 122 (of FIG. 1) in the plurality of artificial intelligence-based hybrid RAID controller devices 1808a-1808n may vary. In an embodiment of the present disclosure, number of SSD in the first array of SSDs 1810a-1810n, and the second array of SSDs 1812a-1812n may vary.

Each of the artificial intelligence-based hybrid RAID controller devices 1804, 1808a-1808n includes CPU, artificial intelligence inference engine module (shown as AI in FIG. 18), DSP module (shown as DSP in FIG. 18) and XOR/Cipher engine module (shown as Cipher in FIG. 18) (as shown in FIG. 18).

Each of the plurality of PCIe switch 1806a-1806n is identical to PCIe switch 204 of FIG. 2. The artificial intelligence-based hybrid RAID controller device 1804, 1808a-1808n is identical to the artificial intelligence-based hybrid RAID controller device 122 of FIG. 1. CPU is identical to the CPU 102 of FIG. 1. Artificial intelligence inference engine module is identical to the artificial intelligence inference engine module 108 of FIG. 1. Each SSD in the first array of SSDs 1810a-1810n and the second array of SSDs 1812a-1812n is identical to SSD of the array of SSDs 118a-118c of FIG. 1.

DSP module is identical to the DSP module 112 of FIG. 1. XOR/Cipher engine module is identical to XOR/Cipher engine module 110 of FIG. 1. In an embodiment of the present disclosure, number of the CPU 102 (of FIG. 1), the artificial intelligence inference engine module 108 (of FIG. 1), the DSP module 112 of FIG. 1 and XOR/Cipher engine module 110 of FIG. 1 may vary.

In an embodiment of the present disclosure, the artificial intelligence-based hybrid RAID controller device 1804 utilizes PCIe switch 1806a to receive input 1802. In one example, input 1802 is received from an external source or surrounding. In another example, input 1802 is received from input device. In yet another example, the artificial intelligence-based hybrid RAID controller device 1804 utilizes any of the plurality of PCIe switch 1806a-1806n to receive input 1802.

Input 1802 is received in variety of formats, such as audio format, image format, video format, animation format, gif format, text format, or any other similar format.

In an example, input 1802 includes sound coming from speaker, physical world, or outside environment. In another example, input 1802 includes a real-time view of the outside world or surrounding captured by a camera. In yet another example, input 1802 includes a real-time video stream coming from the outside world or surrounding captured by a video camera.

The CPU 102 (of FIG. 1) of the corresponding artificial intelligence-based hybrid RAID controller devices 1804, 1808a-1808n processes input 1802. Further, the CPU 102 (of FIG. 1) of the corresponding artificial intelligence-based hybrid RAID controller devices 1804, 1808a-1808n sets up DMA to transfer input 1802. DMA stands for Direct Memory Access. DMA provides ability to input-output devices to access memory without use of the CPU 102 (of FIG. 1). DMA allows streaming of input 1802 from input device to the plurality of PCIe switch 1806a-1806n and the artificial intelligence-based hybrid RAID controller device 1804. In addition, the artificial intelligence-based hybrid RAID controller devices 1804, 1808a-1808n utilizes number of the artificial intelligence inference engine module 108 (of FIG. 1), the DSP module 112 of FIG. 1 and the XOR/Cipher engine module 110 of FIG. 1 to perform faster computing operations. The artificial intelligence-based hybrid RAID controller devices 1804, 1808a-1808n provides real-time insights and tactical decision-making based on the processing of received input 1802 (as explained above in FIG. 1) (as shown in FIG. 18).

FIG. 19 illustrates an isometric top view 1900 of the artificial intelligence-based hybrid RAID controller device 122 (of FIG. 1) implemented on the printed circuit board 1902, in accordance with various embodiments of the present disclosure. The printed circuit board 1902 includes array of SSDs 1904a-1904b, and plurality of USB ports 1906a-1906b. The artificial intelligence-based hybrid RAID controller device 122 (of FIG. 1) is implemented in form of SoC 1908 (as shown in FIG. 19).

Generally, SoC (System on chip) is a small chip that includes all required electronic components and circuits of a system on a single integrated circuit. The SoC 1908 has dimension of 1 inch×1 inch. However, dimensions of the Soc 1908 may vary. Space below the SoC 1908 is used to connect components such as bypass capacitors and the like.

Base of the printed circuit board 1902 has a thickness of 1.6 millimetre. However, thickness of base of the printed circuit board 1902 may vary. The printed circuit board 1902 is of rectangular form. However, form of the printed circuit board 1902 is not limited to above mentioned form.

The printed circuit board 1902 has four corner holes and two mid-board holes to accommodate screws to hold a case frame. However, placement of holes on the printed circuit board 1902 may vary. Screws allow the printed circuit board 1902 to remain stable inside the case frame.

Each SSD of the array of SSDs 1904a-1904b is identical to SSD of the array of SSDs 118a-118c (of FIG. 1). In an embodiment of the present disclosure, the array of SSDs 1904a-1904b are connected either on top or bottom side of the printed circuit board 1902.

One of plurality of USB ports 1906a-1906b is used to consume power supply from an external power source. Remaining of the plurality of USB ports 1906a-1906b is used for data transfer applications. In addition, remaining of the plurality of USB ports 1906a-1906b is used to connect to the host 202 (of FIG. 2).

In an embodiment of the present disclosure, the host 202 is a fixed computing device. In one example, fixed computing device includes desktop, workstation, mainframe computer, and the like. In another embodiment of the present disclosure, the host 202 is a portable computing device. In one example, portable computing device includes laptop, smart watch, camera, Android based smartphone, iOS based smartphone, smartphone based on any other operating system, and the like.

The artificial intelligence-based hybrid RAID controller device 122 (of FIG. 1) connects with the host 202 using one of the plurality of USB ports 1906a-1906b. In an embodiment of the present disclosure, the artificial intelligence-based hybrid RAID controller device 122 (of FIG. 1) connects with the host 202 using wireless technology such as Wi-fi, Bluetooth, and the like.

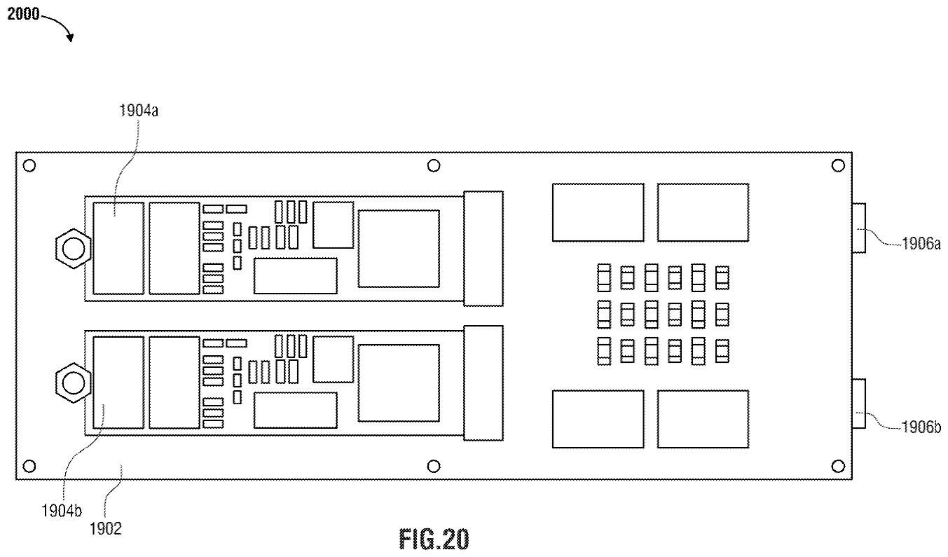

FIG. 20 illustrates an isometric bottom view 2000 of the artificial intelligence-based hybrid RAID controller device 122 (of FIG. 1) implemented on the printed circuit board 1902 (of FIG. 19), in accordance with various embodiments of the present disclosure.

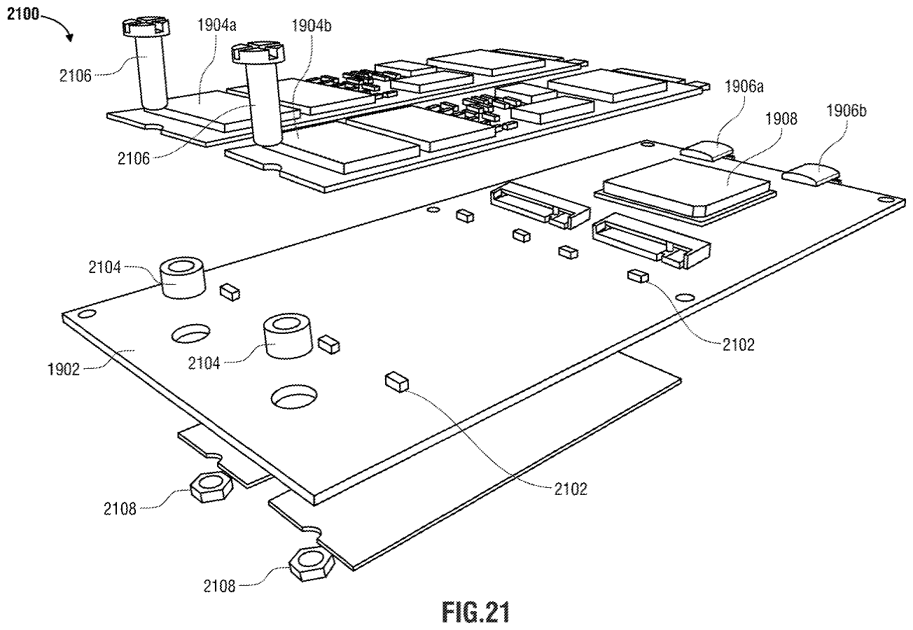

FIG. 21 illustrates an exploded isometric view 2100 of assembly of the printed circuit board 1902 (of FIG. 19), in accordance with various embodiments of the present disclosure.

Isometric view 2100 includes non-conductive solderable spacers 2102, female-female threaded spacers 2104, screw 2106, and hex nut 2108. Non-conductive solderable spacers 2102 are soldered on both top and bottom side of the printed circuit board 1902 (of FIG. 19). Non-conductive solderable spacers 2102 provide additional support to the array of SSDs 118a-118c (of FIG. 1).

The array of SSDs 118a-118c (of FIG. 1) are mounted on bottom side of the printed circuit board 1902 (of FIG. 19). Female-female threaded spacers 2104 are inserted through the printed circuit board 1902 (of FIG. 19). Female-female threaded spacers 2104 have dimensional measurements of 4 millimetre. However, dimensional measurements of female-female threaded spacers 2104 may vary.

The array of SSDs 118a-118c (of FIG. 1) are mounted on top side of the printed circuit board 1902 (of FIG. 19) to enclose non-conductive solderable spacers 2102 in between. The array of SSDs 118a-118c (of FIG. 1) are locked into position using screw 2106, and hex nut 2108.

FIG. 22 illustrates an exploded isometric internal view 2200 of the electronic storage appliance 2202, in accordance with various embodiments of the present disclosure.

The electronic storage appliance 2202 includes the case frame, the artificial intelligence-based hybrid RAID controller device 122 (of FIG. 1), and the array of SSDs 118a-118c (of FIG. 1). The case frame includes an upper frame 2204 and a lower frame 2206. The case frame encloses the artificial intelligence-based hybrid RAID controller device 122 (of FIG. 1). In one example, the case frame encloses the printed circuit board 1902 (of FIG. 19).

The upper frame 2204 is fastened with the lower frame 2206 with facilitation of six flathead M3 screws. However, type of screws may vary. In addition, the case frame includes vents on side for proper air flow. Further, the case frame has rounded edges for proper and better handling.

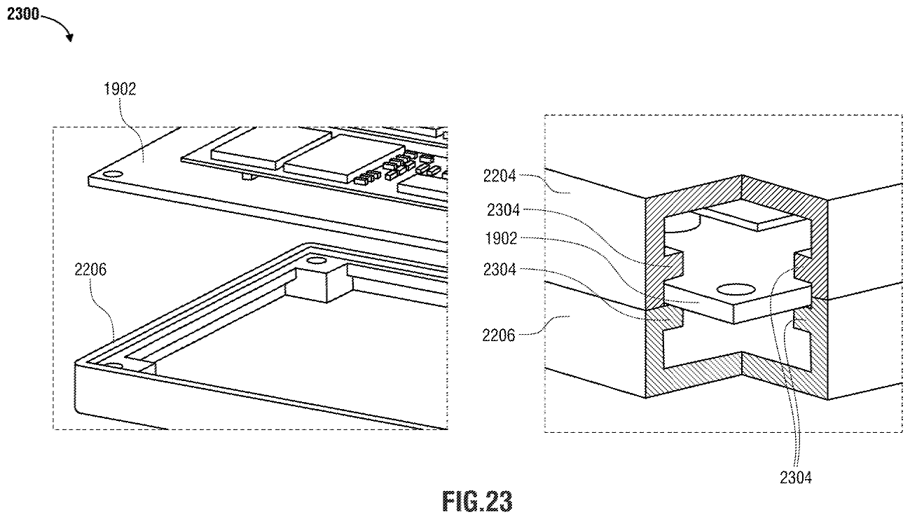

FIG. 23 illustrates a cross-sectional view 2300 of the upper frame 2204 (of FIG. 22) and the lower frame 2206 (of FIG. 22) enclosing the printed circuit board 1902 (of FIG. 19), in accordance with various embodiments of the present disclosure.

Inner side of the upper frame 2204 (of FIG. 22) and the lower frame 2206 (of FIG. 22) includes clamping points 2304 (as shown in FIG. 23) to hold the printed circuit board 1902 (of FIG. 19) in place. In addition, the clamping points 2304 provides stability to the printed circuit board 1902 (of FIG. 19) to prevents its movement.

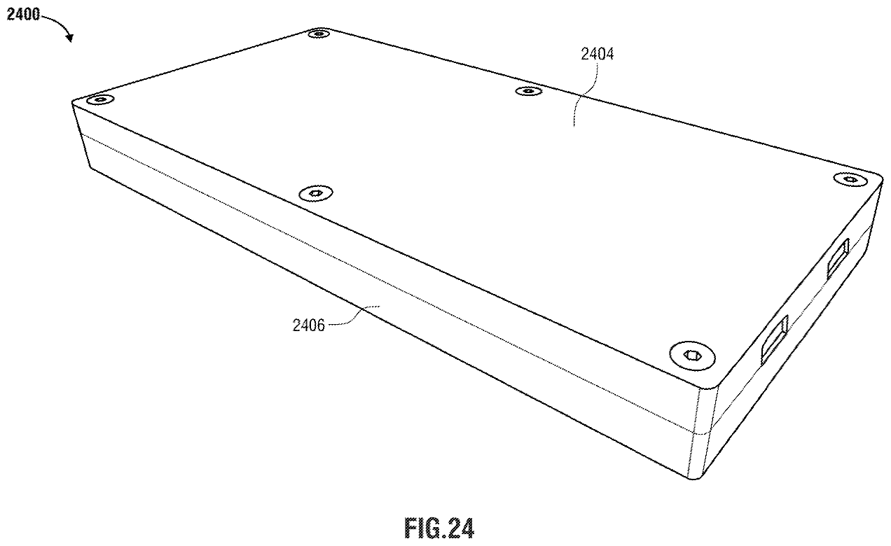

FIG. 24 illustrates an isometric external view 2400 of the electronic storage appliance 2202 (of FIG. 22), in accordance with various embodiments of the present disclosure. The electronic storage appliance 2202 (of FIG. 22) has length of 158 millimetre. The electronic storage appliance 2202 (of FIG. 22) has breadth of 74 millimetre. The electronic storage appliance 2202 (of FIG. 22) has height of 16 millimetre. However, above mentioned dimensions of the electronic storage appliance 2202 (of FIG. 22) may vary.

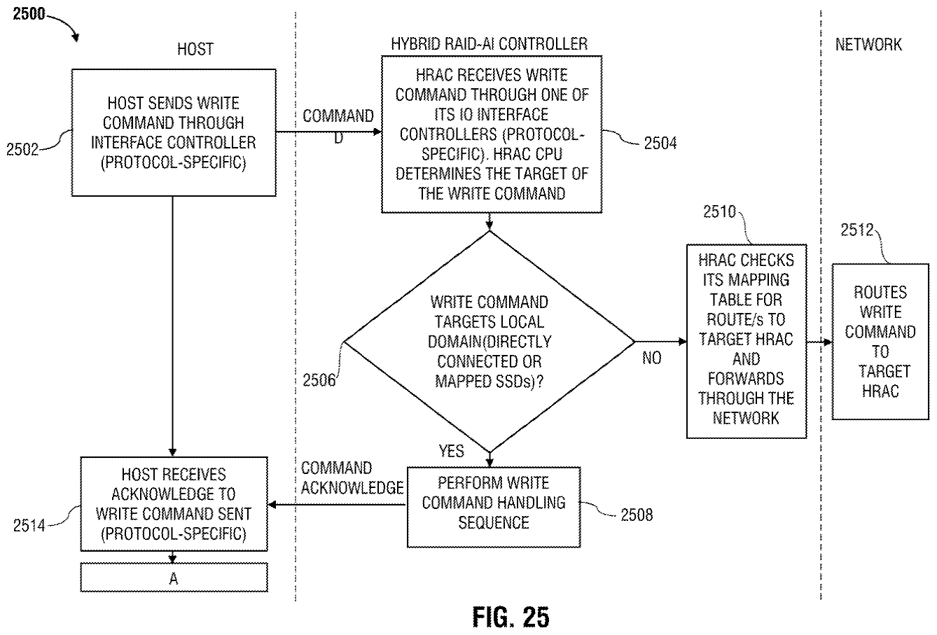

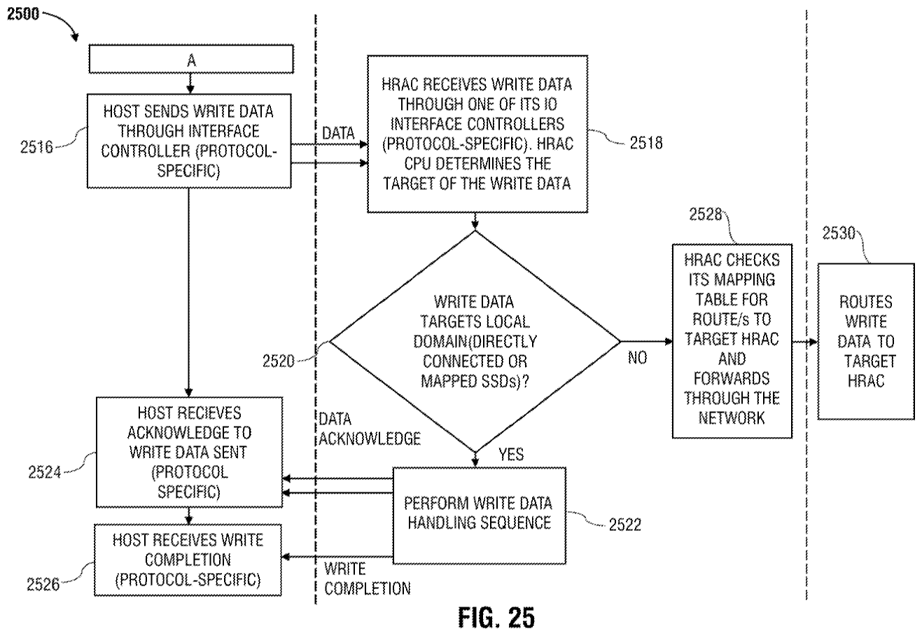

FIG. 25 illustrates flow diagram 2500 of managing the write request by the artificial intelligence-based hybrid RAID controller device 122 (of FIG. 1) received from the another artificial intelligence-based hybrid RAID controller device 122 (of FIG. 1) or the host 202 (of FIG. 2), in accordance with an embodiment of the present disclosure. It may be noted that references will be made to the system elements of FIG. 1-FIG. 18 to explain the process steps of flow diagram 2500.

At step 2502, the host 202 issues the write command through interface controller. At step 2504, the artificial intelligence-based hybrid RAID controller device 122 receives the write command. The artificial intelligence-based hybrid RAID controller device 122 receives the write command through one of the IO controller 116. The CPU 102 of the corresponding artificial intelligence-based hybrid RAID controller device 122 determines the target of the write command. At step 2506, the artificial intelligence-based hybrid RAID controller device 122 finds whether the write command is intended for the directly connected array of SSDs 118a-118c or mapped SSDs in network.

The artificial intelligence-based hybrid RAID controller device 122 detects the write command that is intended for the directly connected array of SSDs 118a-118c. Subsequently, the artificial intelligence-based hybrid RAID controller device 122 performs the write command handling sequence, as shown at step 2508. At step 2510, the artificial intelligence-based hybrid RAID controller device 122 checks its mapping table to determine a route to target artificial intelligence-based hybrid RAID controller device 122 (of FIG. 1). Also, the artificial intelligence-based hybrid RAID controller device 122 checks its mapping table after detection that the write command is intended for mapped SSDs in network. Further, the artificial intelligence-based hybrid RAID controller device 122 forwards the write command through network.

At step 2512, network routes the write command to the target artificial intelligence-based hybrid RAID controller device 122 (of FIG. 1). At step 2514, the host 202 receives protocol-specific acknowledgement to the write command sent. At step 2516, the host 202 sends the write data through interface controller. At step 2518, the artificial intelligence-based hybrid RAID controller device 122 receives the write data through one of the IO controller 116. The CPU 102 of the corresponding artificial intelligence-based hybrid RAID controller device 122 determines target of the write data. At step 2520, the artificial intelligence-based hybrid RAID controller device 122 finds whether the write data is intended for the directly connected array of SSDs 118a-118c or for mapped SSDs in network.

The artificial intelligence-based hybrid RAID controller device 122 detects the write data that is intended for the directly connected array of SSDs 118a-118c. Subsequently, the artificial intelligence-based hybrid RAID controller device 122 performs the write data handling sequence, as shown at step 2522. At step 2524, the host 202 receives protocol-specific acknowledgement to the write data sent from the array of SSDs 118a-118c. At step 2526, the host 202 receives protocol-specific write completion.

At step 2528, the artificial intelligence-based hybrid RAID controller device 122 checks its mapping table to determine route to the target artificial intelligence-based hybrid RAID controller device. Also, the artificial intelligence-based hybrid RAID controller device 122 checks its mapping table after detection that the write data is intended for mapped SSDs in network. Further, the artificial intelligence-based hybrid RAID controller device 122 forwards the write data through network. At step 2530, network routes the write data to the target artificial intelligence-based hybrid RAID controller device.

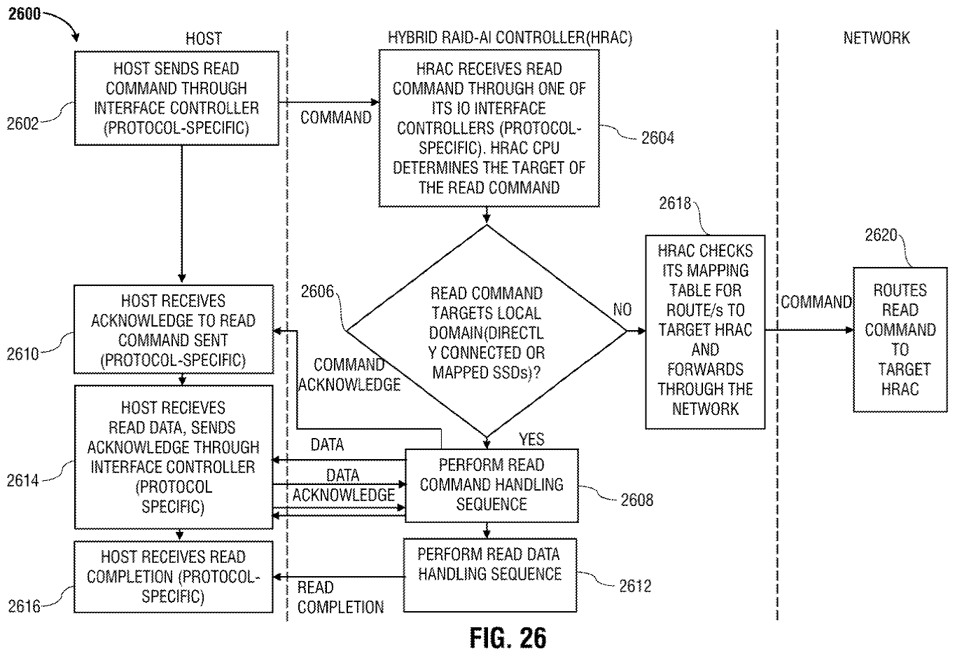

FIG. 26 illustrates flow diagram 2600 of managing sequence flow of the read request by the artificial intelligence-based hybrid RAID controller device 122 (of FIG. 1) received from the another artificial intelligence-based hybrid RAID controller device 122 (of FIG. 1) or the host 202 (of FIG. 2), in accordance with another embodiment of the present disclosure. It may be noted that references will be made to the system elements of FIG. 1-FIG. 18 to explain the process steps of flow diagram 2600.

At step 2602, the host 202 sends read command through interface controller. At step 2604, the artificial intelligence-based hybrid RAID controller device 122 receives read command through one of the IO controller 116. The CPU 102 of the corresponding artificial intelligence-based hybrid RAID controller device 122 determines target of read command. At step 2606, the artificial intelligence-based hybrid RAID controller device 122 finds whether read command is intended for the directly connected array of SSDs 118a-118c or for mapped SSDs in network.

The artificial intelligence-based hybrid RAID controller device 122 detects read command that is intended for the directly connected array of SSDs 118a-118c. Subsequently, the artificial intelligence-based hybrid RAID controller device 122 performs read command handling sequence, as shown at step 2608. At step 2610, the host 202 receives protocol-specific acknowledgement to read command sent. At step 2612, the artificial intelligence-based hybrid RAID controller device 122 performs read data handling sequence. At step 2614, the host 202 receives read data. Further, the host 202 sends acknowledgement to the artificial intelligence-based hybrid RAID controller device 122 through interface controller. At step 2616, the host 202 receives read completion from the artificial intelligence-based hybrid RAID controller device 122.

At step 2618, the artificial intelligence-based hybrid RAID controller device 122 checks its mapping table to determine route to target artificial intelligence-based hybrid RAID controller device. The artificial intelligence-based hybrid RAID controller device 122 checks its mapping table after detection that read command is intended for mapped SSDs in network. Further, the artificial intelligence-based hybrid RAID controller device 122 forwards read command through network. At step 2620, network routes read command to the target artificial intelligence-based hybrid RAID controller device 122 (of FIG. 1).

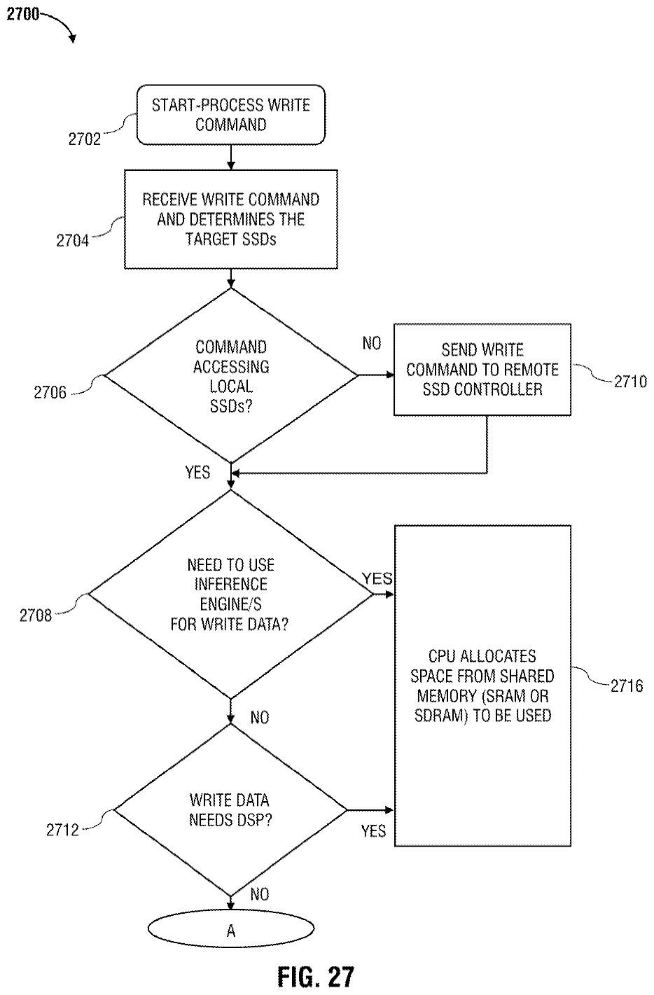

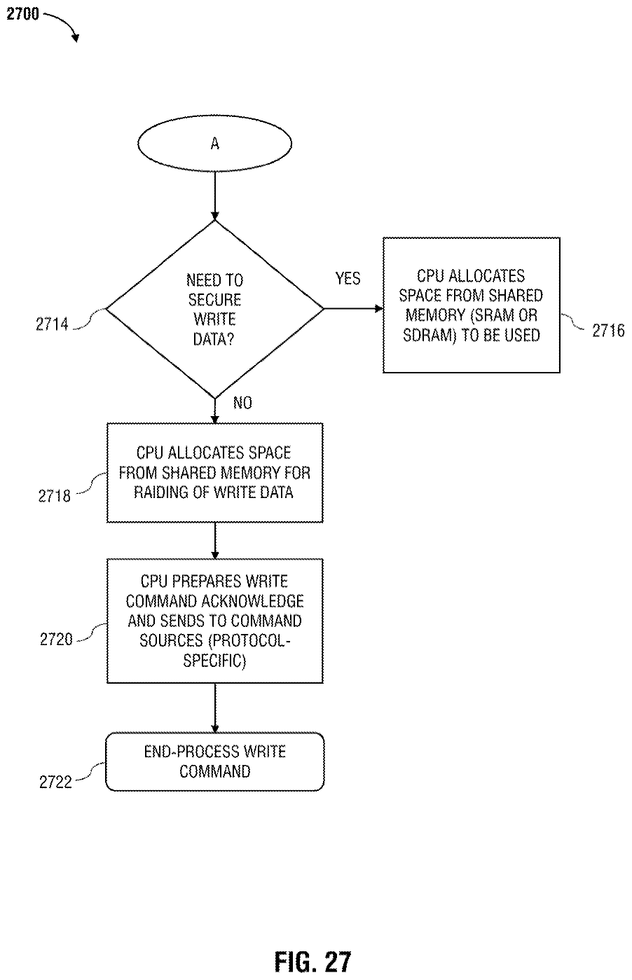

FIG. 27 illustrates flow chart 2700 of handling of the write request by the artificial intelligence-based hybrid RAID controller device 122 (of FIG. 1), in accordance with yet another embodiment of the present disclosure. It may be noted that references will be made to the system elements of FIG. 1-FIG. 18 to explain the process steps of flow chart 2700.

At step 2702, process of the write command is initiated. At step 2704, the artificial intelligence-based hybrid RAID controller device 122 receives the write command. In addition, the artificial intelligence-based hybrid RAID controller device 122 determines target SSD of the array of SSDs 118a-118c. At step 2706, the artificial intelligence-based hybrid RAID controller device 122 determines whether the write command access the array of SSDs 118a-118c. The artificial intelligence-based hybrid RAID controller device 122 determines the write command access the array of SSDs 118a-118c. Subsequently, the artificial intelligence-based hybrid RAID controller device 122 determines if it needs to use the artificial intelligence inference engine module 108 for the write data, as shown at step 2708.

At step 2710, the artificial intelligence-based hybrid RAID controller device 122 sends the write command to remote PCIe controller. Further, the artificial intelligence-based hybrid RAID controller device 122 sends the write command after determination that the write command does not access the array of SSDs 118a-118c. The artificial intelligence-based hybrid RAID controller device 122 determines that the artificial intelligence-based hybrid RAID controller device 122 does not need to use the artificial intelligence inference engine module 108. Subsequently, the artificial intelligence-based hybrid RAID controller device 122 determines if it needs to use the DSP module 112 for the write data, as shown at step 2712. The artificial intelligence-based hybrid RAID controller device 122 determines that the artificial intelligence-based hybrid RAID controller device 122 does not need to use the DSP module 112. Subsequently, the artificial intelligence-based hybrid RAID controller device 122 determines if it needs to use the XOR/Cipher engine module 110 to secure the write data, as shown at step 2714. The steps 2708, 2712 and 2714 may be performed interchangeably.

At step 2716, the CPU 102 allocates space from the SRAM 104 or the DRAM 106. Furthermore, the CPU 102 allocates space after determination that the artificial intelligence-based hybrid RAID controller device 122 requires at least one of the artificial intelligence inference engine module 108, the DSP module 112 or the XOR/Cipher engine module 110.

At step 2718, the CPU 102 allocates space from the SRAM 104 and the DRAM 106 for RAID implementation of the write data. At step 2720, the CPU 102 prepares the write command acknowledgement. Moreover, the CPU 102 sends acknowledgement to command sources. At step 2722, process of the write command is terminated.

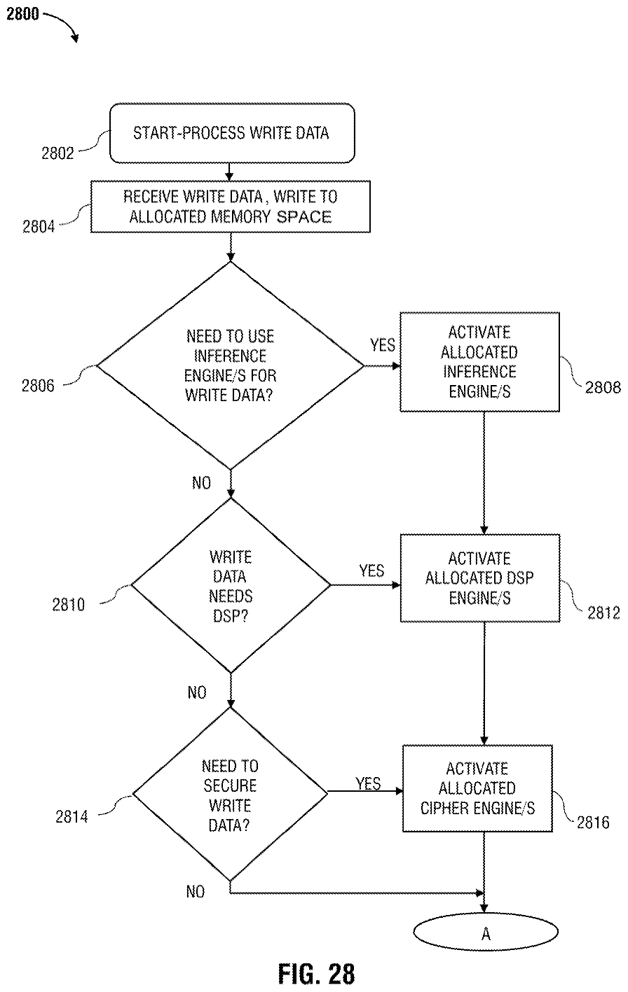

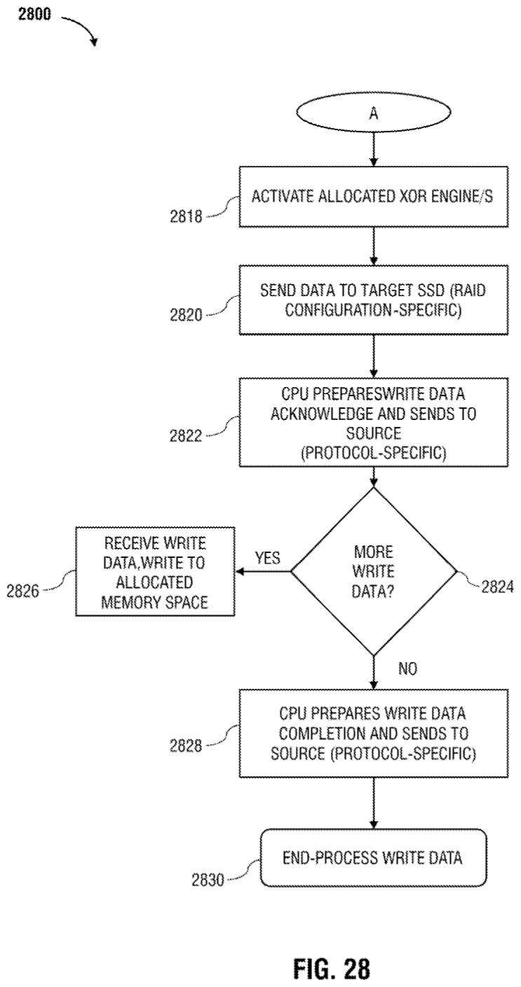

FIG. 28 illustrates flow chart 2800 of handling of the write data by the artificial intelligence-based hybrid RAID controller device 122 (of FIG. 1), in accordance with yet another embodiment of the present disclosure. It may be noted that references will be made to the system elements of FIG. 1-FIG. 18 to explain the process steps of flow diagram 2800.

At step 2802, process of the write data is initiated. At step 2804, the artificial intelligence-based hybrid RAID controller device 122 receives the write data. Also, the artificial intelligence-based hybrid RAID controller device 122 writes to allocated space in the SRAM 104 and the DRAM 106. At step 2806, the artificial intelligence-based hybrid RAID controller device 122 determines if it needs to use the artificial intelligence inference engine module 108 for the write data. The artificial intelligence-based hybrid RAID controller device 122 determines whether the artificial intelligence-based hybrid RAID controller device 122 needs to use the artificial intelligence inference engine module 108 for the write data. Subsequently, the artificial intelligence-based hybrid RAID controller device 122 activates the artificial intelligence inference engine module 108, as shown at step 2808. The artificial intelligence-based hybrid RAID controller device 122 determines that the artificial intelligence-based hybrid RAID controller device 122 does not need to use the artificial intelligence inference engine module 108. Subsequently, the artificial intelligence-based hybrid RAID controller device 122 determines if it needs to use the DSP module 112 for the write data, as shown at step 2810. The artificial intelligence-based hybrid RAID controller device 122 determines whether the artificial intelligence-based hybrid RAID controller device 122 needs to use the DSP module 112 for the write data. Subsequently, the artificial intelligence-based hybrid RAID controller device 122 activates the allocated DSP module 112, as shown at step 2812. The steps 2806, 2810 and 2814 may be performed interchangeably.

At step 2814, the artificial intelligence-based hybrid RAID controller device 122 determines whether it needs to secure the write data. The artificial intelligence-based hybrid RAID controller device 122 determines whether the artificial intelligence-based hybrid RAID controller device 122 needs to secure the write data. Subsequently, the artificial intelligence-based hybrid RAID controller device 122 activates the AES engines of the XOR/Cipher engine module 110, as shown at step 2816.

The artificial intelligence-based hybrid RAID controller device 122 determines whether the artificial intelligence-based hybrid RAID controller device 122 does not need to secure the write data. Subsequently, the artificial intelligence-based hybrid RAID controller device 122 activates the XOR engines of the XOR/Cipher engine module 110, as shown at step 2818. At step 2820, the artificial intelligence-based hybrid RAID controller device 122 sends data to target SSD of the array of SSDs 118a-118c (RAID configuration-specific).

At step 2822, the CPU 102 prepares the write data acknowledgement. Moreover, the CPU 102 sends the write data acknowledgement to source (protocol-specific). At step 2824, the artificial intelligence-based hybrid RAID controller device 122 determines whether more of the write data is required or not. At step 2826, the artificial intelligence-based hybrid RAID controller device 122 receives the write data. Also, the artificial intelligence-based hybrid RAID controller device 122 writes it to allocated memory space in the SRAM 104 and the DRAM 106 upon determination that more of the write data is required. At step 2828, the CPU 102 prepares the write data completion and sends to source (protocol-specific). Moreover, the CPU 102 prepares the write data completion and sends to source after determination that more of the write data is not required. At step 2830, process of the write data is terminated.

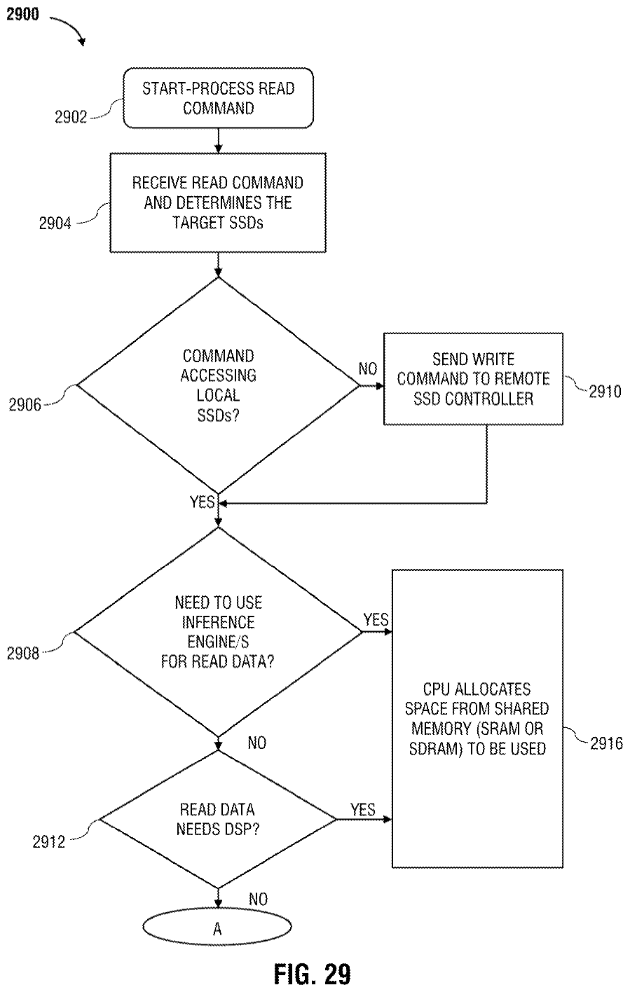

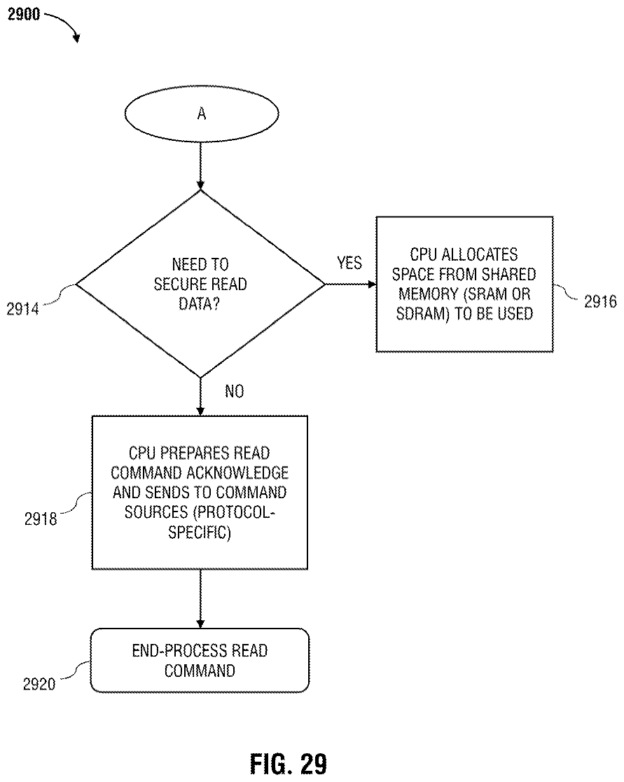

FIG. 29 illustrates flow diagram 2900 of handling of the read request by the artificial intelligence-based hybrid RAID controller device 122 (of FIG. 1), in accordance with yet another embodiment of the present disclosure. It may be noted that references will be made to the system elements of FIG. 1-FIG. 18 to explain the process steps of flow diagram 2900.

At step 2902, process of read command is initiated. At step 2904, the artificial intelligence-based hybrid RAID controller device 122 receives read command. Also, the artificial intelligence-based hybrid RAID controller device 122 determines target SSD of the array of SSDs 118a-118c. At step 2906, the artificial intelligence-based hybrid RAID controller device 122 determines whether read command access the array of SSDs 118a-118c.

At step 2908, the artificial intelligence-based hybrid RAID controller device 122 determines if it needs to use the artificial intelligence inference engine module 108 for read data.

The artificial intelligence-based hybrid RAID controller device 122 determines that read command does not access the array of SSDs 118a-118c. Subsequently, the artificial intelligence-based hybrid RAID controller device 122 sends read command to remote PCIe controller, as shown at step 2910. The artificial intelligence-based hybrid RAID controller device 122 determines that the artificial intelligence-based hybrid RAID controller device 122 does not need to use the artificial intelligence inference engine module 108. Subsequently, the artificial intelligence-based hybrid RAID controller device 122 determines if it needs to use the DSP module 112 for read data, as shown at step 2912. The artificial intelligence-based hybrid RAID controller device 122 determines that the artificial intelligence-based hybrid RAID controller device 122 does not need to use the DSP module 112. Subsequently, the artificial intelligence-based hybrid RAID controller device 122 determines if it needs to use the XOR/Cipher engine module 110 to secure read data, as shown at step 2914. The steps 2908, 2910 and 2914 may be performed interchangeably.

At step 2916, the CPU 102 allocates space from the SRAM 104 or the DRAM 106. Also, the CPU 102 allocates space after determination that the artificial intelligence-based hybrid RAID controller device 122 requires at least one of the artificial intelligence inference engine module 108, the DSP module 112 or the XOR/Cipher engine module 110.

At step 2918, the CPU 102 prepares read command acknowledgement. Moreover, the CPU 102 sends acknowledgement to command source. At step 2920, process of read command is terminated.

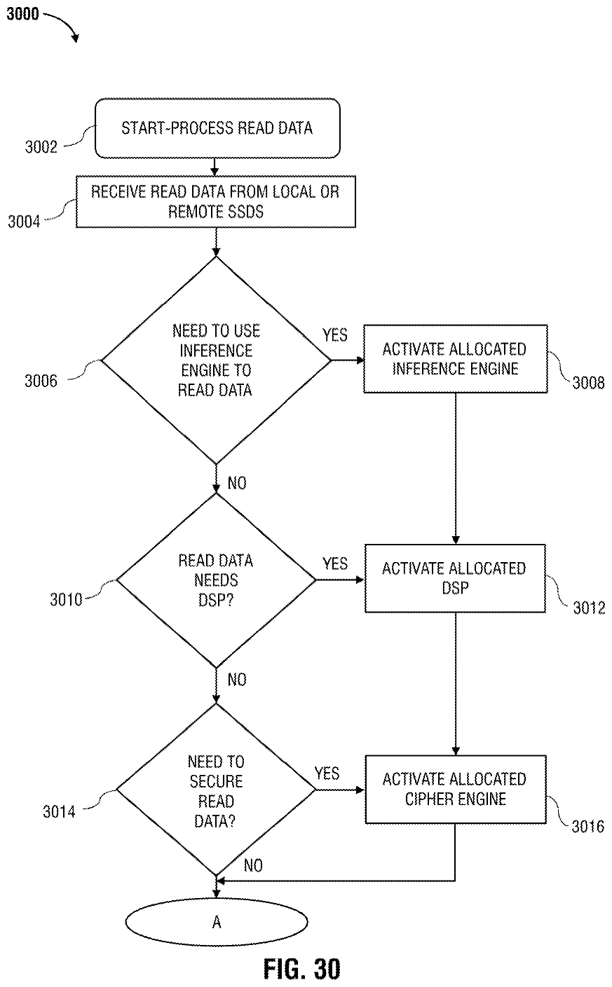

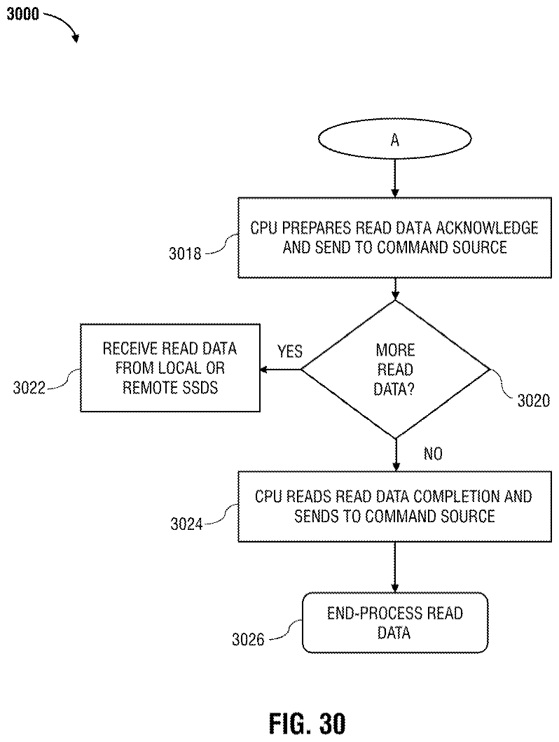

FIG. 30 illustrates flow diagram of handling of read data by the artificial intelligence-based hybrid RAID controller device, in accordance with various embodiments of the present disclosure. It may be noted that references will be made to the system elements of FIG. 1-FIG. 18 to explain the process steps of flow diagram 3000.

At step 3002, process of read data is initiated. At step 3004, the artificial intelligence-based hybrid RAID controller device 122 receives read data from the local array of SSDs 118a-118c or remote SSDs. At step 3006, the artificial intelligence-based hybrid RAID controller device 122 determines if it needs to use the artificial intelligence inference engine module 108 to read data. The artificial intelligence-based hybrid RAID controller device 122 determines whether the artificial intelligence-based hybrid RAID controller device 122 needs to use the artificial intelligence inference engine module 108 to read data. Subsequently, the artificial intelligence-based hybrid RAID controller device 122 activates the artificial intelligence inference engine module 108, as shown at step 3008. The artificial intelligence-based hybrid RAID controller device 122 determines that the artificial intelligence-based hybrid RAID controller device 122 does not need to use the artificial intelligence inference engine module 108. Subsequently, the artificial intelligence-based hybrid RAID controller device 122 determines if it needs to use the DSP module 112 to read data, as shown at step 3010. The artificial intelligence-based hybrid RAID controller device 122 determines whether the artificial intelligence-based hybrid RAID controller device 122 needs to use the DSP module 112 to read data. Subsequently, the artificial intelligence-based hybrid RAID controller device 122 activates the allocated DSP module 112, as shown at step 3012. The steps 3006, 3010 and 3014 may be performed interchangeably.

At step 3014, the artificial intelligence-based hybrid RAID controller device 122 determines whether it needs to secure read data. The artificial intelligence-based hybrid RAID controller device 122 determines whether the artificial intelligence-based hybrid RAID controller device 122 needs to secure read data. Subsequently, the artificial intelligence-based hybrid RAID controller device 122 activates the AES engines of the XOR/Cipher engine module 110, as shown at step 3016.

At step 3018, the CPU 102 prepares read data acknowledgement. Moreover, the CPU 102 sends read data acknowledgement to command source. At step 3020, the artificial intelligence-based hybrid RAID controller device 122 determines whether more read data is required or not. At step 3022, the artificial intelligence-based hybrid RAID controller device 122 receives read data from the local array of SSDs 118a-118c or remote SSDs. At step 3024, the CPU 102 reads read data completion. Also, the CPU 102 sends to command source after determination that more read data is not required. At step 3026, process of read data is terminated.

The present disclosure provides numerous advantages over the prior arts. The present disclosure provides artificial intelligence-based hybrid RAID controller device. Artificial intelligence-based hybrid RAID controller device is used to provide a secured, highly reliable and highly scalable electronic storage appliance.

In addition, artificial intelligence-based hybrid RAID controller device includes XOR/Cipher engine module. The XOR/Cipher engine module provides data security. Further, artificial intelligence-based hybrid RAID controller device includes artificial intelligence inference engine module and DSP module to perform artificial intelligence-based tasks. Furthermore, the artificial intelligence-based hybrid RAID controller device employs artificial intelligence inference engine module and DSP module facilitates to perform in-storage processing.

Moreover, the artificial intelligence-based hybrid RAID controller device is connected with array of SSDs to provide highly scalable electronic storage appliance. Also, the CPU of artificial intelligence-based hybrid RAID controller device resides closely with plurality of SSDs to perform faster computing operations. Also, use of artificial intelligence inference engine module and DSP module closely with plurality of SSDs allows artificial intelligence-based hybrid RAID controller device to perform faster artificial intelligence-based tasks. Also, artificial intelligence-based hybrid RAID controller device employs XOR/Cipher engine module, artificial intelligence inference engine module and DSP module in single device along with plurality of SSDs to provide faster computation capabilities.

In the following detailed description, for purposes of explanation, numerous specific details are set forth to provide a thorough understanding of the various embodiments of the present invention. Those of ordinary skill in the art will realize that these various embodiments of the present invention are illustrative only and are not intended to be limiting in any way. Other embodiments of the present invention will readily suggest themselves to such skilled persons having the benefit of this disclosure.

In addition, for clarity purposes, not all of the routine features of the embodiments described herein are shown or described. One of ordinary skill in the art would readily appreciate that in the development of any such actual implementation, numerous implementation-specific decisions may be required to achieve specific design objectives. These design objectives will vary from one implementation to another and from one developer to another. Moreover, it will be appreciated that such a development effort might be complex and time-consuming, but would nevertheless be a routine engineering undertaking for those of ordinary skill in the art having the benefit of this disclosure. The various embodiments disclosed herein are not intended to limit the scope and spirit of the herein disclosure.

Exemplary embodiments for carrying out the principles of the present invention are described herein with reference to the drawings. However, the present invention is not limited to the specifically described and illustrated embodiments. A person skilled in the art will appreciate that many other embodiments are possible without deviating from the basic concept of the invention. Therefore, the principles of the present invention extend to any work that falls within the scope of the appended claims.

We claim:

1. An artificial intelligence-based hybrid RAID controller device comprising:
CPU to execute instructions to run overall operation of the artificial intelligence-based hybrid RAID controller device;
XOR/Cipher engine module embedding AES engines to perform encryption and decryption to provide data security, wherein the XOR/Cipher engine module embeds XOR engines to perform RAID parity computation to provide data redundancy;
DSP module to perform pre-processing of data for an artificial intelligence inference engine module;
the artificial intelligence inference engine module to facilitate the artificial intelligence-based hybrid RAID controller device to perform in-storage processing, wherein the artificial intelligence inference engine module provides artificial intelligence-based processing capabilities to the artificial intelligence-based hybrid RAID controller device; and
a plurality of PCIe controller, wherein the plurality of PCIe controller is connected to an array of SSDs, wherein each of the plurality of PCIe controller manages independent SSD of the array of SSDs, wherein the array of SSDs is connected to the artificial intelligence-based hybrid RAID controller device to store data, wherein the artificial intelligence-based hybrid RAID controller device provides a secure, reliable, and scalable electronic storage appliance.

2. The artificial intelligence-based hybrid RAID controller device of claim 1, further comprising SRAM to perform faster operations on data, wherein the SRAM creates a buffer to store data and metadata for short term, wherein the SRAM receives data from the CPU using an internal bus crossbar.

3. The artificial intelligence-based hybrid RAID controller device of claim 1, further comprising DRAM to create a buffer to store data and metadata for short term, wherein the DRAM receives data from the CPU using an internal bus crossbar.

4. The artificial intelligence-based hybrid RAID controller device of claim 1, further comprising an IO controller to facilitate communication with a host through a high-speed interconnect.

5. The artificial intelligence-based hybrid RAID controller device of claim 1, wherein the artificial intelligence-based hybrid RAID controller device supports hot plugging of the array of SSDs.

6. The artificial intelligence-based hybrid RAID controller device of claim 1, wherein each of the array of SSDs is of same configuration or different configuration.

7. The artificial intelligence-based hybrid RAID controller device of claim 1, wherein the artificial intelligence-based hybrid RAID controller device is implemented as a system on a chip (SoC)on a printed circuit board.

8. A secure, reliable and scalable electronic storage appliance comprising:
a case frame enclosing an artificial intelligence-based hybrid RAID controller device, wherein the case frame comprises an upper frame and a lower frame;
the artificial intelligence-based hybrid RAID controller device; and
an array of SSDs, wherein the array of SSDs is connected to the artificial intelligence-based hybrid RAID controller device to store data.

9. The electronic storage appliance of claim 8, wherein the artificial intelligence-based hybrid RAID controller device comprises XOR/Cipher engine module, wherein the XOR/Cipher engine module embeds AES engines to perform encryption and decryption to provide data security, wherein the XOR/Cipher engine module embeds XOR engines to perform RAID parity computation to provide data redundancy.

10. The electronic storage appliance of claim 8, wherein the artificial intelligence-based hybrid RAID controller device comprises DSP module to perform pre-processing of data for an artificial intelligence inference engine module.

11. The electronic storage appliance of claim 8, wherein the artificial intelligence-based hybrid RAID controller device comprises an artificial intelligence inference engine module to facilitate the artificial intelligence-based hybrid RAID controller device to perform in-storage processing, wherein the artificial intelligence inference engine module provides artificial intelligence-based processing capabilities to the artificial intelligence-based hybrid RAID controller device.

12. The electronic storage appliance of claim 8, wherein the artificial intelligence-based hybrid RAID controller device comprises SRAM to perform faster operations on data, wherein the SRAM creates a buffer to store data and metadata for short term, wherein the SRAM receives data from CPU using an internal bus crossbar.

13. The electronic storage appliance of claim 8, wherein the artificial intelligence-based hybrid RAID controller device comprises DRAM to create a buffer to store data and metadata for short term, wherein the DRAM receives data from the CPU using an internal bus crossbar.

14. The electronic storage appliance of claim 8, wherein the artificial intelligence-based hybrid RAID controller device comprises a plurality of PCIe controller, wherein the plurality of PCIe controller is connected to the array of SSDs, wherein each of the plurality of PCIe controller manages independent SSD of the array of SSDs.

15. The electronic storage appliance of claim 8, wherein the artificial intelligence-based hybrid RAID controller device comprises an IO controller to facilitate communication with a host through a high-speed interconnect.

16. A method for providing secure, reliable and efficient data storage with facilitation of an artificial intelligence-based hybrid RAID controller device, the method comprising:
receiving, by an IO controller, a read request or a write request from a host;
determining, by CPU, corresponding SSD of an array of SSDs to issue the read request or the write request;
issuing, by the CPU to handle the write request, a write command for data to be written to the corresponding SSD of the array of SSDs; and
receiving, by the CPU to handle the read request, data from the corresponding SSD of the array of SSDs, wherein the CPU receives data with facilitation of a plurality of PCIe controller.

17. The method of claim 16, further comprising implementing RAID operation, upon activation of XOR/Cipher engine module, during handling of the read request or the write request received from the host, wherein RAID operation is implemented with facilitation of XOR engines embedded inside the XOR/Cipher engine module in the artificial intelligence-based hybrid RAID controller device, wherein RAID operation is implemented to compute parity block to provide data redundancy.

18. The method of claim 17, wherein the XOR engines embedded inside the XOR/Cipher engine module reads, during handling of the write request, each data block in a set of data blocks buffered in SRAM and DRAM, wherein the SRAM and the DRAM buffer the parity block to store the parity block in any PCIe controller of the plurality of PCIe controller and the set of data blocks are stored in remaining PCIe controller of the plurality of PCIe controller.

19. The method of claim 17, further comprising reading, by the plurality of PCIe controller, a set of data blocks and parity blocks from the array of SSDs during processing of the read request, wherein the plurality of PCIe controller reads the parity blocks to regenerate missing or corrupted data stored in the array of SSDs.

20. The method of claim 16, further comprising buffering, by the IO controller, the read request or the write request received from the host in SRAM and DRAM, wherein the IO controller buffers the read request or the write request with facilitation of a high-speed interconnect.

21. The method of claim 16, further comprising buffering, by the IO controller, data received from the corresponding SSD of the array of SSDs in SRAM and DRAM, wherein the IO controller buffers data with facilitation of a high-speed interconnect.

22. The method of claim 16, further comprising performing encryption, upon activation by XOR/Cipher engine module, on each data block of a set of data blocks before writing the set of data blocks to the array of SSDs, wherein the XOR/Cipher engine module performs encryption to provide data security.

23. The method of claim 16, further comprising performing decryption, during handling of the read command, on each data block of a set of data blocks received from the array of SSDs, wherein the decryption is performed by XOR/Cipher engine module.

24. The method of claim 16, further comprising performing in-storage processing, at the artificial intelligence-based hybrid RAID controller device, by offloading compute functions from the CPU and performing processing of data directly at the array of SSDs, wherein in-storage processing is performed by an artificial intelligence inference engine module and DSP module embedded inside the artificial intelligence-based hybrid RAID controller device.

25. The method of claim 16, further comprising pre-processing of data, upon activation by DSP module embedded inside the artificial intelligence-based hybrid RAID controller device, wherein the DSP module performs pre-processing of data for an artificial intelligence inference engine module, wherein the DSP module performs pre-processing on data received from the IO controller.
